(19) United States
(12) Patent Application Publication
(10) Pub. No.: US 2009/0135213 A1
(43) Pub. Date: May 28, 2009

(54) DISPLAY

(75) Inventors: Kazunari Tomizawa, Kyoto (JP); Kozo Nakamura, Nara (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/066,866

(22) PCT Filed: Jun. 16, 2006
(86) PCT No.: PCT/JP2006/312154

§ 371 Date: Mar. 14, 2008

(30) Foreign Application Priority Data
Sep. 16, 2005 (JP) 2005-270979

(51) Int. Cl. G09G 5/02

(52) U.S. Cl. 345/697

(57) ABSTRACT

A display device includes a pixel defined by a plurality of sub-pixels. The plurality of sub-pixels include first, second, third and fourth sub-pixels. A second hue of the second sub-pixel is closest to a first hue of the first sub-pixel in the chromaticity diagram of the L*a*b* color system, and a third hue of the third sub-pixel is closest to the first hue on the opposite side to the second hue with respect to the first hue in the chromaticity diagram of the L*a*b* color system among the hues. The luminances of the plurality of sub-pixels are set such that while a color displayed by the pixel changes from black via the first color of the first sub-pixel to white, the luminance of the first sub-pixel starts to be increased, and when the luminance of the first sub-pixel reaches a predetermined luminance, the luminance of at least one of the second sub-pixel and the third sub-pixel starts to be increased.

### BACKGROUND OF THE INVENTION

1. Field of the Invention

The present invention relates to a display device for displaying an image using four or more primary colors.

2. Description of the Related Art

Color display devices such as color TVs, color monitors and the like usually represent colors by additive color mixture of RGB primary colors (i.e., red, green and blue). Pixels of color display devices each include red, green and blue sub-pixels in correspondence with the RGB primary colors. Various colors are represented by setting the luminance of each of the red, green and blue sub-pixels to a desired level.

The luminance of each sub-pixel varies in the range from the lowest gray scale level thereof (e.g., gray scale level 0) to the highest gray scale level thereof (e.g., gray scale level 255). Herein, the luminance of a sub-pixel at the lowest gray scale level thereof is represented as “0”, and the luminance of the sub-pixel at the highest gray scale level thereof is represented as “1”, for the sake of convenience. The luminance of a sub-pixel is controlled in the range of “0” to “1”.

When the luminances of all the sub-pixels, i.e., the red, green and blue sub-pixels are “0”, the color displayed by the pixel is black. By contrast, when the luminances of all the sub-pixels are “1”, the color displayed by the pixel is white. Recently, many TVs allow a user to adjust the color temperature. The color temperature is adjusted by fine-tuning the luminance of each sub-pixel. Herein, the luminance of a sub-pixel after the color temperature is desirably adjusted is represented as “1”.

With reference to FIG. 25, a change of the color displayed by a pixel from black via red to white by changing the luminance of each sub-pixel in a conventional display device will be described. In the following description, the color displayed only by a red sub-pixel is represented as “R”, and a hue of such a color is represented as “hue (R)” or simply as “(R)”.

FIG. 25 shows the relationship between a change in the luminance of each of the sub-pixels and a change of the color displayed by the pixel in the conventional display device. (a) shows a change of the color displayed by the pixel, and (b) shows a change in the luminance of each of the red, green and blue sub-pixels.

Initially, the color displayed by the pixel is black, and the luminance of each of the red, green and blue sub-pixels is “0”. First, the luminance of the red sub-pixel starts to be increased. As the luminance of the red sub-pixel increases, the chroma and the lightness of the color displayed by the pixel increase. When the luminance of the red sub-pixel becomes “1”, the chroma of the color in the hue (R) displayed by the pixel is maximized. In the following description, a color having the maximum chroma in a hue will be referred to as the “optimal color”. For the optimal color, the L*a*b* color system will be used.

After reaching “1”, the luminance of the red sub-pixel is kept at “1”. Then, the luminances of the green and blue sub-pixels start to be increased in order to further increase the lightness of the pixel. The luminances of the green and blue sub-pixels increase by the same rate. By increasing the luminances of the green and blue sub-pixels by the same rate, the lightness of the pixel can be increased without changing the hue (R). When the luminances of all the sub-pixels become “1”, the color displayed by the pixel is white. In the conventional display device, the color displayed by the pixel can be changed from black to white via red having a high chroma by changing the luminances of the sub-pixels as described above.

In the conventional display device, yellow is represented by additive color mixture of red and green. With reference to FIG. 26, a change of the color displayed by the pixel from black via yellow to white in the conventional display device will be described.

FIG. 26 shows the relationship between a change in the luminance of each of the sub-pixels and a change of the color displayed by the pixel in the conventional display device. (a) shows a change of the color displayed by the pixel, and (b) shows a change in the luminance of each of the red, green and blue sub-pixels.

Initially, the color displayed by the pixel is black, and the luminances of all the sub-pixels are “0”. First, the luminances of the red and green sub-pixels increase by the same rate to “1”. When the luminances of the red and green sub-pixels reach “1”, the color displayed by the pixel is the optimal color in the yellow hue. After reaching “1”, the luminances of the red and green sub-pixels are kept at “1”. Then, the luminance of the blue sub-pixel starts to be increased in order to further increase the lightness of the pixel. By increasing the luminance of the blue sub-pixel while the luminances of the red and green sub-pixels are kept at “1”, the lightness of the pixel can be increased without changing the yellow hue. When the luminances of all the sub-pixels become “1”, the color displayed by the pixel is white. In the conventional display device, the color displayed by the pixel can be changed from black to white via yellow having a high chroma by changing the luminances of the sub-pixels as described above.

In the above example, yellow is displayed by additive color mixture. Various colors can be displayed by setting the luminance of each of the red, green and blue sub-pixels at an arbitrary level.

As opposed to the above-described display device using three primary colors, a display device using additive color mixture of four or more primary colors has been proposed. In such a display device, other colors are used in addition to the RGB colors in order to broaden the range of colors which can be represented (see, for example, Japanese National Phase PCT Laid-Open Patent Publication No. 2004-529396).

### SUMMARY OF THE INVENTION

However, according to the studies performed by the present inventors, colors of a wider representation range cannot be displayed in actuality by simply adding colors to the three primary colors.

Preferred embodiments of the present invention developed in light of the above-described problems provide a display device capable of displaying colors in a wide representation range.

A display device according to a preferred embodiment of the present invention includes a pixel defined by a plurality of sub-pixels. The plurality of sub-pixels include a first sub-pixel representing a first color having a first hue, a second sub-pixel representing a second color having a second hue, a third sub-pixel representing a third color having a third hue, and a fourth sub-pixel representing a fourth color having a fourth hue. The second hue is closest to the first hue in a chromaticity diagram of the L*a*b* color system among the hues of the plurality of sub-pixels, and the third hue is closest to the first hue on the opposite side to the second hue with respect to the first hue in the chromaticity diagram of the L*a*b* color system among the hues of the plurality of sub-pixels. The luminances of the plurality of sub-pixels are set such that while a color displayed by the pixel changes from black via the first color to white, the luminance of the first sub-pixel starts to be increased, and when the luminance of the first sub-pixel reaches a predetermined luminance, the luminance of at least one of the second sub-pixel and the third sub-pixel among the plurality of sub-pixels starts to be increased.

In one preferred embodiment, the luminances of the second sub-pixel and the third sub-pixel start to be increased such that the hue of the color displayed by the pixel does not change from the first hue.

In one preferred embodiment, the luminance of the sub-pixel corresponding to a hue most remote from the first hue among the hues of the plurality of sub-pixels starts to be increased after the luminances of the other sub-pixels start to be increased.

In one preferred embodiment, the first color is any one of red, green and blue; and when the luminance of the first sub-pixel reaches the predetermined luminance, the color displayed by the pixel is the optimal color in the first hue.

In one preferred embodiment, the first color is any one of yellow, cyan and magenta; and when the luminances of the first, second and third sub-pixels reach respective predetermined luminances, the color displayed by the pixel is the optimal color in the first hue.

In one preferred embodiment, when the luminance of one of the second and third sub-pixels reaches a predetermined luminance, the luminance of the fourth sub-pixel starts to be increased.

In one preferred embodiment, the rate of the predetermined luminance with respect to the luminance corresponding to the highest gray scale level of the first sub-pixel is about 0.8 or greater and about 1 or less.

In one preferred embodiment, the predetermined luminance is the luminance corresponding to the highest gray scale level of the first sub-pixel.

In one preferred embodiment, in the case where the first, second, third and fourth colors are any of red, green, blue and yellow, when the first color is red, the second and third colors are yellow and blue; when the first color is green, the second and third colors are yellow and blue; when the first color is blue, the second and third colors are red and green; and when the first color is yellow, the second and third colors are red and green.

In one preferred embodiment, the plurality of sub-pixels further include a fifth sub-pixel representing a fifth color having a fifth hue; the fifth hue is closest to the first hue next to the second hue on the same side as the second hue with respect to the first hue in the chromaticity diagram of the L*a*b* color system among the hues of the plurality of sub-pixels; and when the luminance of the second pixel reaches a predetermined luminance, the luminance of the fifth sub-pixel starts to be increased.

In one preferred embodiment, wherein the first color is any one of yellow, cyan and magenta; and when the luminances of the first, second and third sub-pixels reach respective predetermined luminances, the luminances of the fourth and fifth sub-pixels start to be increased at the same time.

In one preferred embodiment, in the case where the first, second, third, fourth and fifth colors are any of red, green, blue, yellow and cyan, when the first color is red, the second and third colors are yellow and blue; when the first color is green, the second and third colors are yellow and cyan; when the first color is blue, the second and third colors are red and cyan; when the first color is yellow, the second and third colors are red and green; and when the first color is cyan, the second and third colors are blue and green.

In one preferred embodiment, the plurality of sub-pixels further include a sixth sub-pixel representing a sixth color having a sixth hue; the sixth hue is closest to the first hue next to the third hue on the same side as the third hue with respect to the first hue in the chromaticity diagram of the L*a*b* color system among the hues of the plurality of sub-pixels; and when the luminance of the third hue reaches a predetermined luminance, the luminance of the sixth sub-pixel starts to be increased.

In one preferred embodiment, in the case where the first, second, third, fourth, fifth and sixth colors are any of red, green, blue, yellow, cyan and magenta, when the first color is red, the second and third colors are yellow and magenta; when the first color is green, the second and third colors are yellow and cyan; when the first color is blue, the second and third colors are magenta and cyan; when the first color is yellow, the second and third colors are red and green; when the first color is cyan, the second and third colors are blue and green; and when the first color is magenta, the second and third colors are blue and red.

A display device according to preferred embodiments of the present invention includes a pixel. The pixel can perform display with any combination of any luminance of a first color having a first hue, a second color having a second hue, a third color having a third hue and a fourth color having a fourth hue. The second hue is closest to the first hue in a chromaticity diagram of the L*a*b* color system among the hues of the pixel, and the third hue is closest to the first hue on the opposite side to the second hue with respect to the first hue in the chromaticity diagram of the L*a*b* color system among the hues of the pixel. The luminances of the colors of the pixel are set such that while a color displayed by the pixel changes from black via the first color to white, the luminance of the first color starts to be increased, and when the luminance of the first color reaches a predetermined luminance, the luminance of at least one of the second color and the third color starts to be increased.

A display device according to preferred embodiments of the present invention can display colors in a wide representation range.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic block diagram of a display device according to a preferred embodiment of the present invention.

FIG. 2(a) is a schematic diagram showing a color space three-dimensional image of the L*a*b* color system, and FIG. 2(b) is a chromaticity diagram of the L*a*b* color system.

FIG. 3 is a chromaticity diagram of the L*a*b* color system, in which a* and b* of each color of five sub-pixels in a display device in the first preferred embodiment are plotted.

FIG. 4 is a schematic diagram showing the relationship between a change in the luminance of each of the sub-pixels and the color representation range in the display device in the first preferred embodiment; (a) is a color tone diagram showing the color representation range of the pixel, (b) shows a change of the color displayed by the pixel, and (c) shows a change in the luminance of each of red, yellow, blue, green and cyan sub-pixels.

FIG. 5 is a schematic diagram showing the relationship between a change in the luminance of each of sub-pixels and the color representation range in a display device of a comparative example; (a) is a color tone diagram showing the color representation range of the pixel, (b) shows a change of the color displayed by the pixel, and (c) shows a change in the luminance of each of the red, yellow, blue, green and cyan sub-pixels.

FIG. 6 is a schematic chromaticity diagram of the XYZ color system.

FIG. 7 is a graph showing the relationship between the chroma and the lightness when the luminance of each sub-pixel is changed as shown in Table 2 in the display device in the first preferred embodiment.

FIG. 8 is a graph showing the relationship between the chroma and the lightness when the luminance of each sub-pixel is changed as shown in Table 3 in the display device in the first preferred embodiment.

FIG. 9 is a schematic block diagram of an image processing circuit in the display device in the first preferred embodiment.

FIG. 10 is a schematic diagram showing the difference between the display device in the first preferred embodiment and the conventional display device.

FIG. 11 is a chromaticity diagram of the L*a*b* color system, in which a* and b* of each color of four sub-pixels in a display device in the second preferred embodiment are plotted.

FIG. 12 is a chromaticity diagram of the L*a*b* color system, in which a* and b* of each color of six sub-pixels in a display device in the third preferred embodiment are plotted.

FIG. 13 is a chromaticity diagram of the L*a*b* color system, in which a* and b* of each color of five sub-pixels in a display device in the fourth preferred embodiment are plotted.

FIG. 14 is a schematic diagram showing the relationship between a change in the luminance of each of the sub-pixels and the color representation range in the display device in the fourth preferred embodiment; (a) is a color tone diagram showing the color representation range of the pixel, (b) shows a change of the color displayed by the pixel, and (c) shows a change in the luminance of each of yellow, red, green, cyan and blue sub-pixels.

FIG. 15 is a schematic diagram showing the relationship between a change in the luminance of each of sub-pixels and the color representation range in a display device of a comparative example; (a) is a color tone diagram showing the color representation range of the pixel, (b) shows a change of the color displayed by the pixel, and (c) shows a change in the luminance of each of the yellow, red, green, cyan and blue sub-pixels.

FIG. 16 is a schematic diagram showing the difference between the display device in the fourth preferred embodiment and the conventional display device.

FIG. 17 is a schematic diagram showing the relationship between a change in the luminance of each of the sub-pixels and the color representation range in the display device in the fourth preferred embodiment; (a) is a color tone diagram showing the color representation range of the pixel, (b) shows a change of the color displayed by the pixel, and (c) shows a change in the luminance of each of yellow, red, green, cyan and blue sub-pixels.

FIG. 18 is a schematic diagram showing the relationship between a change in the luminance of each of the sub-pixels and the color representation range in the display device in the fourth preferred embodiment; (a) is a color tone diagram showing the color representation range of the pixel, (b) shows a change of the color displayed by the pixel, and (c) shows a change in the luminance of each of yellow, red, green, cyan and blue sub-pixels.

FIG. 19 is a chromaticity diagram of the L*a*b* color system, in which a* and b* of each color of four sub-pixels in a display device in the fifth preferred embodiment are plotted.

FIG. 20 is a chromaticity diagram of the L*a*b* color system, in which a* and b* of each color of six sub-pixels in a display device in the sixth preferred embodiment are plotted.

FIG. 21 is a schematic diagram showing the relationship between a change in the luminance of each of the sub-pixels and the color representation range in the display device in the sixth preferred embodiment; (a) is a color tone diagram showing the color representation range of the pixel, (b) shows a change of the color displayed by the pixel, and (c) shows a change in the luminance of each of yellow, red, green, cyan, magenta and blue sub-pixels.

FIG. 22 is a schematic diagram showing the relationship between a change in the luminance of each of the sub-pixels and the color representation range in the display device in the sixth preferred embodiment; (a) is a color tone diagram showing the color representation range of the pixel, (b) shows a change of the color displayed by the pixel, and (c) shows a change in the luminance of each of yellow, red, green, cyan, magenta and blue sub-pixels.

FIG. 23 is a schematic diagram showing the relationship between a change in the luminance of each of the sub-pixels and the color representation range in the display device in the sixth preferred embodiment; (a) is a color tone diagram showing the color representation range of the pixel, (b) shows a change of the color displayed by the pixel, and (c) shows a change in the luminance of each of yellow, red, green, cyan, magenta and blue sub-pixels.

FIG. 24 is a schematic diagram showing the relationship between a change in the luminance of each of the sub-pixels and the color representation range in the display device in the sixth preferred embodiment; (a) is a color tone diagram showing the color representation range of the pixel, (b) shows a change of the color displayed by the pixel, and (c) shows a change in the luminance of each of yellow, red, green, cyan, magenta and blue sub-pixels.

FIG. 25 is a schematic diagram showing the relationship between a change in the luminance of each of sub-pixels and a change of the color displayed by the pixel in a conventional display device; (a) is a color tone diagram showing a change of the color displayed by the pixel, and (b) shows a change in the luminance of each of the red, green and blue sub-pixels.

FIG. 26 is a schematic diagram showing the relationship between a change in the luminance of each of sub-pixels and a change of the color displayed by the pixel in a conventional display device; (a) is a color tone diagram showing a change of the color displayed by the pixel, and (b) shows a change in the luminance of each of the red, green and blue sub-pixels.

### DETAILED DESCRIPTION OF THE PREFERRED EMBODIMENTS

### First Preferred Embodiment

Hereinafter, a display device according to a first preferred embodiment of the present invention will be described with reference to the drawings.

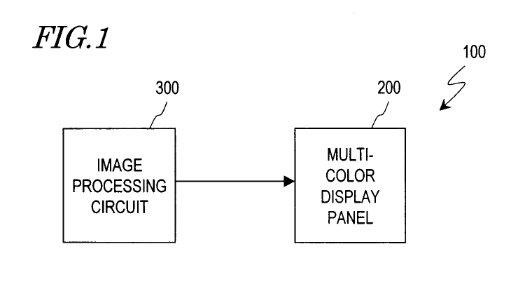

FIG. 1 is a schematic block diagram showing a display device 100 according to this preferred embodiment. As shown in FIG. 1, the display device 100 includes a multi-color display panel 200 and an image processing circuit 300 for generating a signal to be input to the multi-color display panel 200. The multi-color display panel 200 is, for example, a liquid crystal panel. The multi-color display panel 200 includes a plurality of pixels, and an each pixel is defined by a plurality of sub-pixels. In the display device 100 of this preferred embodiment, each pixel includes five sub-pixels (red, green, blue, yellow and cyan sub-pixels).

In the following description, the color displayed only by a red sub-pixel is represented as “R”, and a hue of such a color is represented as “hue (R)” or simply as “(R)”. Similarly, the color displayed only by a green sub-pixel is represented as “G”, and a hue of such a color is represented as “hue (G)” or simply as “(G)”. The color displayed only by a blue sub-pixel is represented as “B”, and a hue of such a color is represented as “hue (B)” or simply as “(B)”. The color displayed only by a yellow sub-pixel is represented as “Ye”, and a hue of such a color is represented as “hue (Ye)” or simply as “(Ye)”. The color displayed only by a cyan sub-pixel is represented as “C”, and a hue of such a color is represented as “hue (C)” or simply as “(C)”. The five sub-pixels in one pixel are realized by, for example, forming five different sub-pixel areas per pixel area in a color filter (not shown) provided in the multi-color display panel 200.

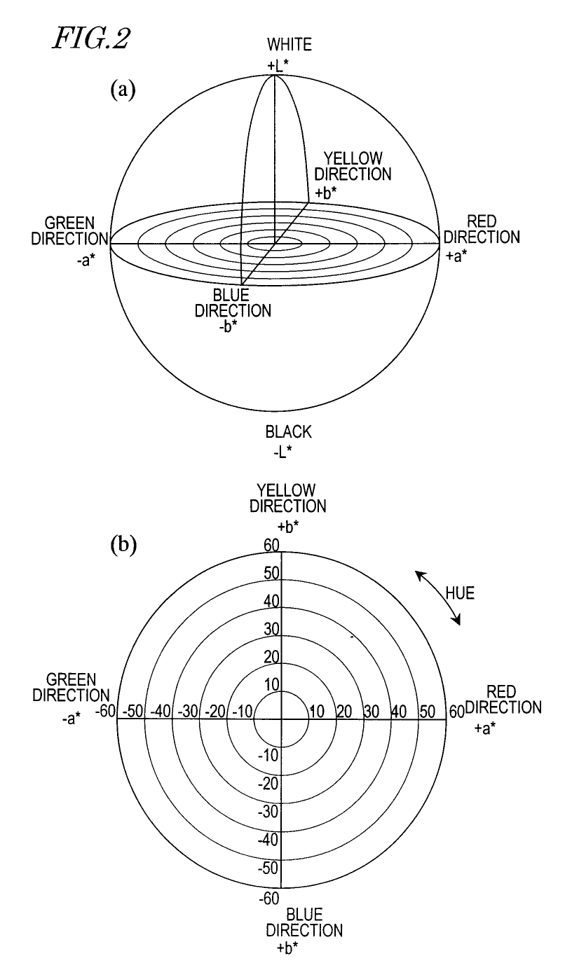

FIG. 2(a) a schematic diagram showing a color space three-dimensional image of the L*a*b* color system. In FIG. 2(a), the lightness is represented by L*, and the hue and the chroma are specified by chromaticity a* and b*. Specifically, where C*=√((a*)²+(b*)²), the chroma is represented by C* and the hue is represented by the hue angle tan⁻¹(b*/a*). As shown in FIG. 2(a), the lightness is higher (closer to white) as being larger in the +L direction and is lower (closer to black) as being larger in the −L direction.

FIG. 2(b) is a chromaticity diagram of the L*a*b* color system. The chromaticity diagram in FIG. 2(b) corresponds to a cross-sectional view of the schematic diagram in FIG. 2(a) taken along the horizontal direction. As shown in FIGS. 2(a) and 2(b), +a* direction represents a red direction, −a* direction represents a green direction, +b* direction represents a yellow direction, and −b* direction represents a blue direction. As the absolute value of the chromaticity a* or b* is larger, the chroma is higher (the color is more vivid), whereas as the absolute value thereof is smaller, the chroma is lower (the color is more dull).

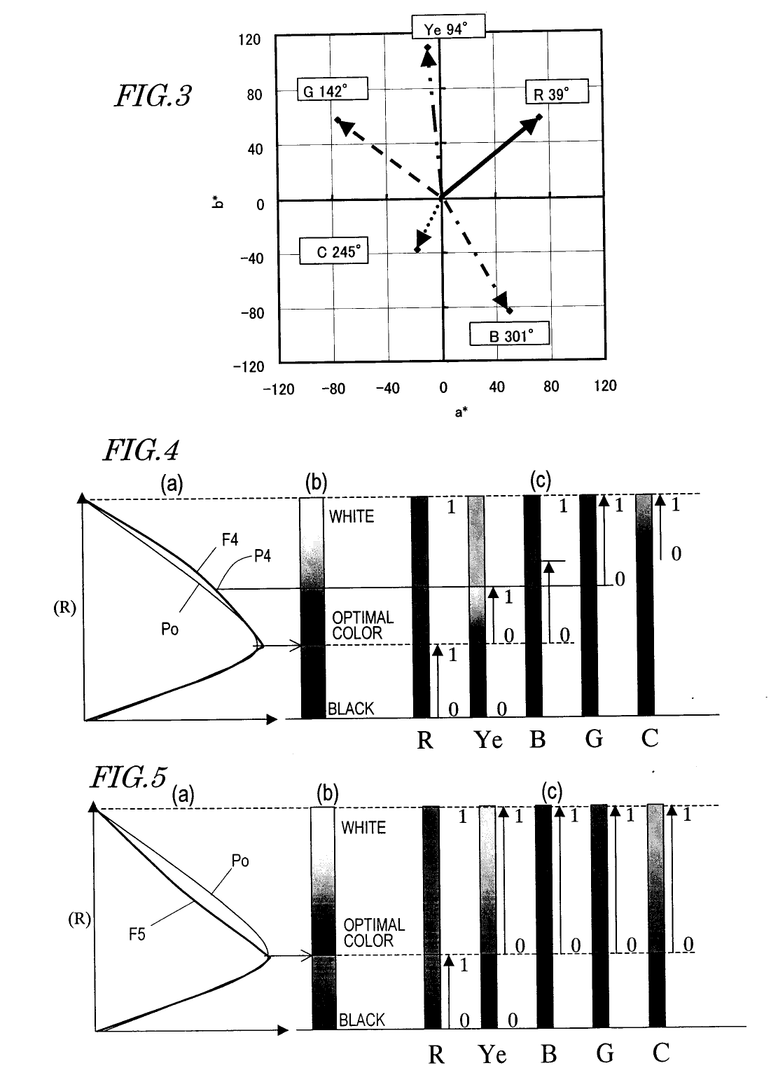

FIG. 3 is a chromaticity diagram of the L*a*b* color system, in which a* and b* of each color of the five sub-pixels in the display device 100 of this preferred embodiment are plotted. FIG. 3 shows the hue angle of the color displayed only by each sub-pixel. The hue angle is an angle of each hue in the counterclockwise direction with respect to the axis of the a* direction (red direction), which is 0°. As shown in FIG. 3, the hue angle is 39° for R, 94° for Ye, 142° for G, 245° for C, and 301° for B.

With reference to FIG. 3, the closeness/remoteness between hues will be discussed. The closeness/remoteness between hues is represented by the difference in the hue angle. Where the hue angle between one hue and another hue is small, the hues are close to each other; whereas where the hue angle between one hue and another hue is large, the hues are remote from each other. Now, the closeness of the hues to the hue (R) of R will be discussed. The hue closest to (R) is (Ye) (hue angle difference: 55°), the hue next closest to (R) is (B) (hue angle difference: 98°), the hue next closest to (R) is (G) (hue angle difference: 103°), and the hue most remote from (R) is (C) (hue angle difference: 154°). (Ye) is in the counterclockwise direction with respect to (R), and (B) is in the clockwise direction with respect to (R). Namely, in the chromaticity diagram of the L*a*b* color system, (Ye) is on the opposite side to (B) with respect to (R). In the chromaticity diagram of the L*a*b* color system, (G) is on the same side as (Ye) with respect to (R), and (C) is on the same side as (B) with respect to (R).

In the chromaticity diagram of the L*a*b* color system, the hue closest to (R) in the counterclockwise direction is (Ye), and the hue closest to (R) in the clockwise direction is (B). Herein, in this case, (Ye) and (B) are also expressed as being adjacent to (R) on both sides in the chromaticity diagram of the L*a*b* color system. Here, the chromaticity diagram of the L*a*b* color system is referred to for discussing the closeness of the hues (G), (B), (Ye) and (C) to the hue (R) Alternatively, the hues (R), (G), (B), (Ye) and (C) may be represented on a hue circle for discussing the closeness of the hues (G), (B), (Ye) and (C) to the hue (R).

Hereinafter, with reference to FIG. 4, a change of the color displayed by the pixel from black via red to white will be described. FIG. 4 is a schematic diagram showing the relationship between a change in the luminance of each of the sub-pixels and the color representation range of the pixel in the display device 100 of this preferred embodiment. FIG. 4(a) is a color tone diagram showing the color representation range of the pixel. In a color tone diagram, the horizontal axis represents the chroma (also represented as “C*”), and the vertical axis represents the lightness (also represented as “L*”). FIG. 4(b) shows a change of the color displayed by the pixel, and FIG. 4(c) shows a change in the luminance of each of the red, yellow, blue, green and cyan sub-pixels.

The luminance of each sub-pixel varies in the range from the lowest gray scale level thereof (e.g., gray scale level 0) to the highest gray scale level thereof (e.g., gray scale level 255). Herein, the luminance of a sub-pixel at the lowest gray scale level thereof is represented as “0”, and the luminance of the sub-pixel at the highest gray scale level thereof is represented as “1”, for the sake of convenience. The luminance of a sub-pixel changes in the range of “0” to “1”.

Initially, the luminances of all the sub-pixels, i.e., the red, yellow, blue, green and cyan sub-pixels are “0”, and the color displayed by the pixel is black. First, the luminance of the red sub-pixel starts to be increased. As the luminance of the red sub-pixel increases, the chroma and the lightness of the pixel increase. When the luminance of the red sub-pixel reaches “1”, the color displayed by the pixel is the optimal hue in the hue (R).

After reaching “1”, the luminance of the red sub-pixel is kept at “1”. Then, the luminances of the yellow and blue sub-pixels start to be increased in order to further increase the lightness of the pixel. When the luminances of the yellow and blue sub-pixels increase, the chroma of the color displayed by the pixel decreases. The luminances of the yellow and blue sub-pixels increase at different rates, such that the hue (R) does not change. In this example, the increasing rate of the luminance of the yellow sub-pixel is larger than that of the blue sub-pixel. The reason is that if the luminances of the yellow and blue sub-pixels increase by the same rate, the hue of the color displayed by the pixel is changed from the hue (R) to the hue (B). The increasing rate of the luminance of each of the yellow and blue sub-pixels is set such that the hue (R) displayed by the pixel does not change.

Ideally, the luminances of the yellow and blue sub-pixels start increasing at the same time. However, as described above, the increasing rate of the luminance of the yellow sub-pixel is larger than that of the blue sub-pixel. Therefore, in actuality, as a result of quantization or the like of various numerical values in the circuit actually performing this control, there may be an occasion that the luminance of the yellow sub-pixel first starts to be increased, and then the luminance of the blue sub-pixel starts to be increased.

The increasing rate of the luminance of the yellow sub-pixel is larger than that of the blue sub-pixel. Hence, the luminance of the yellow sub-pixel reaches “1” before the luminance of the blue sub-pixel. After reaching “1”, the luminance of the yellow sub-pixel is kept at “1”. When the luminance of the yellow sub-pixel reaches “1”, the luminance of the green sub-pixel starts to be increased. The increasing rate of the luminance of the green sub-pixel is also set such that the hue (R) does not change along with the increase in the luminances of the green and blue sub-pixels.

The luminance of the blue sub-pixel reaches “1” before the luminance of the green sub-pixel. After reaching “1”, the luminance of the blue sub-pixel is kept at “1”. When the luminance of the blue sub-pixel reaches “1”, the luminance of the cyan sub-pixel starts to be increased. The increasing rate of the luminance of the cyan sub-pixel is also set such that the hue (R) does not change along with the increase in the luminances of the green and cyan sub-pixels. The luminances of the green and cyan sub-pixels increase so as to reach “1” at the same time. When the luminances of all the sub-pixels reach “1”, the color displayed by the pixel is white.

The color displayed by the pixel is changed as shown in FIG. 4(b) from black via the optimal color in the hue (R) to white by changing the luminance of each sub-pixel as described above. Curve F4 in FIG. 4(a) represents the locus of the change in the chroma and the lightness of the color displayed by the pixel when the luminance of each sub-pixel is changed as shown in FIG. 4(c).

Although described later in detail, curve F4 shows the upper limit of the chroma and the lightness of the color in the hue (R) which can be displayed by the pixel. When the lightness of red is changed by changing the luminance of each sub-pixel in a different manner from the manner shown in FIG. 4(c), the chroma of the color displayed by the pixel cannot be larger than the chroma represented by curve F4. Accordingly, the display device in this preferred embodiment can represent the color in hue (R) having the chroma and the lightness in the range enclosed by the vertical axis and curve F4. In the following description, this range will be referred to also as the “color representation range”.

In FIG. 4(a), Po shows an area of the Pointer gamut in the hue (R). Pointer gamut is a color range of the object colors of objects existing in the natural world, and represents the maximum range of the chroma and the lightness of the object colors of objects existing in the natural world. As shown in FIG. 4(a), the color representation range of the display device covers the area of the hue (R) of the Pointer gamut. Therefore, the display device 100 can represent (display) the maximum possible number of colors of the objects existing in the natural world.

With reference to FIG. 3 again, a change in the chroma when the luminance of only the red sub-pixel is changed while keeping the luminances of the other sub-pixels to “0” will be described.

When the luminances of all the sub-pixels including the red sub-pixel are “0”, the color displayed by the pixel is black and the chroma thereof is zero. In the chromaticity diagram of the L*a*b* color system shown in FIG. 3, this corresponds to the point of the chroma of zero (origin). As the luminance of the red sub-pixel increases, the chromaticity a* and b* of the color displayed by the pixel change from the origin along the arrow directed to R in FIG. 3. When the luminance of the red sub-pixel reaches “1”, the chromaticity a* and b* are most remote from the origin in the direction of the arrow (i.e., a* is about 70 and b* is about 60). In the case where the multi-color display panel 200 (FIG. 1) is a liquid crystal panel, the a* and b* values when the luminance of the red sub-pixel is “1” are determined by the color filter (not shown) and the light source (not shown).

With reference to FIGS. 3 and 4, the order of the sub-pixels in which the luminance is increased will be described. As described above with reference to FIG. 4, with the display device 100 in this preferred embodiment, the luminance of the red sub-pixel is first starts to be increased, and then the luminances of the yellow and blue sub-pixels, the luminance of the green sub-pixel, and the luminance of the cyan sub-pixel start to be increased in this order, for the purpose of increasing the lightness of the pixel.

With reference to FIG. 3, this order will be described. The luminance of the red sub-pixel corresponding to the hue (R) is first increased, and then the luminances of the yellow and blue sub-pixels corresponding to the hues (Ye) and (B) adjacent to the hue (R) are increased. Then, when the luminance of the yellow sub-pixel reaches “1”, the luminance of the green sub-pixel corresponding to (G) which is on the same side as (Ye) with respect to (R) starts to be increased. When the luminance of the blue sub-pixel reaches “1”, the luminance of the cyan sub-pixel corresponding to (C) which is on the same side as (B) with respect to (R) starts to be increased. In this manner, with the display device 100 in this preferred embodiment, the increase of the luminance is started with the red sub-pixel corresponding to the hue (R) which is displayed by the pixel and then in the order from the sub-pixel corresponding a color closer to the hue (R).

The conceivable reason why the display device 100 can provide a wide color representation range by increasing the luminances of the sub-pixels in the order described above is the following. After the luminance of the red sub-pixel reaches “1”, the luminance of the sub-pixels corresponding to another hue(s) needs to be increased in order to further increase the lightness of the pixel. Whichever sub-pixel may be increased in the luminance, the chroma of the color displayed by the pixel decreases. Where a color remote from the hue (R) is added to red, the chroma of red is significantly decreased. By contrast, where a color close to the hue (R) is added to red, the chroma of red is not much decreased. Hence, in order to suppress the decrease in the chroma and increase the lightness, it is more advantageous to start increasing the luminance of a sub-pixel corresponding to the hue closer to the hue (R) than the luminance of a sub-pixel corresponding to the hue remote from the hue (R). For this reason, the display device 100 in this preferred embodiment can represent colors with a wide color representation range with the decrease in the chroma being suppressed.

Now, the display device 100 in this preferred embodiment will be compared with a display device in a comparative example to explain the advantages of the display device 100 in this preferred embodiment. In the display device of the comparative example, each pixel includes five sub-pixels, i.e., red, green, blue, yellow and cyan sub-pixels like in the display device 100 of this preferred embodiment.

As described above with reference to FIG. 25, with the conventional display device, after the luminance of the red sub-pixel reaches “1”, the luminances of the green and blue sub-pixels start to be increased at the same time. With the display device in the comparative example, similar to with the conventional display device, after the luminance of the red sub-pixel reaches “1”, the luminances of the yellow, green, blue and cyan sub-pixels start to be increased at the same time. FIG. 5 is a schematic diagram showing the relationship between a change in the luminance of each of the sub-pixels and the color representation range in the display device of the comparative example. FIG. 5(a) is a color tone diagram showing the color representation range of the pixel. FIG. 5(b) shows a change of the color displayed by the pixel, and FIG. 5(c) shows a change in the luminance of each of the red, yellow, blue, green and cyan sub-pixels.

With the display device in the comparative example also, the luminances of all the sub-pixels, i.e., the red, yellow, blue, green and cyan sub-pixels are initially “0”, and the color displayed by the pixel is black. First, the luminance of the red sub-pixel starts to be increased. As the luminance of the red sub-pixel increases, the chroma and the lightness of the color displayed by the pixel increase. With the display device in the comparative example, after the luminance of the red sub-pixel reaches “1”, the luminances of the yellow, blue, green and cyan sub-pixels start to be increased at the same time as shown in FIG. 5(c). The luminances of the yellow, blue, green and cyan sub-pixels increase by the same rate. In this case also, the lightness of the color displayed by the pixel increases as the luminances of the sub-pixels increase. When the luminances of all the sub-pixels become “1”, the color displayed by the pixel is white.

With the display device in the comparative example, the color displayed by the pixel is changed as shown in FIG. 5(b) from black via the optimal color in the hue (R) to white by changing the luminance of each sub-pixel as shown in FIG. 5(c).

However, as shown in FIG. 5(a), the color representation range of the display device in the comparative example does not sufficiently cover the area of the hue (R) of the Pointer gamut. Therefore, the display device in the comparative example cannot sufficiently represent (display) the object colors of the objects existing in the natural world.

Comparing FIGS. 4(c) and 5(c), the display device 100 in this preferred embodiment and the display device in the comparative example both change the luminance of each sub-pixel in substantially the same manner from the time when the color displayed by the pixel is black until the time when the color displayed by the pixel is the optimal color in the hue (R), but not in the same manner from the time when the color displayed by the pixel is the optimal color in the hue (R) until the time when the color displayed by the pixel is white. Specifically, with the display device 100 in this preferred embodiment, after the luminances of the yellow and blue sub-pixels start to be increased, the luminances of the green sub-pixel and the cyan sub-pixel start to be increased in this order. By contrast, with the display device in the comparative example, the yellow, blue, green and cyan sub-pixels start to be increased at the same time. As a result, curve F4 in FIG. 4(a) represents a relatively high chroma even at a lightness higher than the lightness of the optimal color; whereas curve F5 in FIG. 5(a) represents a relatively low chroma at a lightness higher than the lightness of the optimal color. Namely, the display device 100 in this preferred embodiment, which changes the luminances of the sub-pixels as described above, can represent a color having a high chroma which cannot be represented by the display device in the comparative example. Accordingly, the display device 100 in this preferred embodiment can increase the chroma at each lightness of the color displayed by the pixel, and thus display an image with a wide color representation range.

It should be noted that the above explanation given with reference to FIG. 4 is not only regarding the timing to start lighting up the sub-pixels (the timing to increase the luminance) for changing the color displayed by the pixel from black via red to white. The above explanation given with reference to FIG. 4 is nothing but an algorithm for setting the luminance (display gray scale level) of sub-pixels corresponding to a color displayed by the pixel. Namely, with the display device 100 in this preferred embodiment, a combination of the luminances of the sub-pixels for displaying a color corresponding to each point on curve F4 in FIG. 4(a) is set based on the algorithm. In other words, FIG. 4(c) shows the timing to start lighting up the sub-pixels (the timing to start increasing the luminances), and also a combination itself of the luminances of the sub-pixels for displaying a color corresponding to each point on curve F4. For example, for displaying a color corresponding to point P4 on curve F4 shown in FIG. 4(a), the luminances of the red, yellow, blue, green and cyan sub-pixels are set to (“1”, “1”, “0.7”, “0”, “0”). The luminance of each sub-pixel may be prepared in advance based on the algorithm, or may be generated by calculations. In this manner, the display device 100 in this preferred embodiment can display a color, which cannot be displayed by the conventional display device, based on the algorithm.

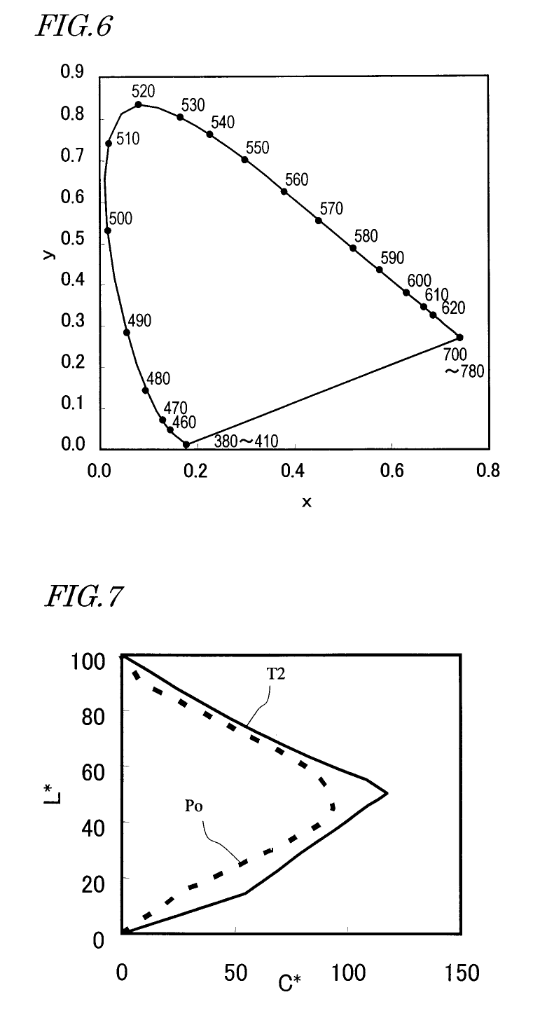

FIG. 6 is a schematic chromaticity diagram of the XYZ color system. FIG. 6 shows the spectrum locus and the dominant wavelength. Herein, a sub-pixel corresponding to a dominant wavelength of 615 nm or longer and 635 nm or shorter is referred to as the “red sub-pixel”, a sub-pixel corresponding to a dominant wavelength of 565 nm or longer and 580 nm or shorter is referred to as the “yellow sub-pixel”, a sub-pixel corresponding to a dominant wavelength of 520 nm or longer and 550 nm or shorter is referred to as the “green sub-pixel”, a sub-pixel corresponding to a dominant wavelength of 475 nm or longer and nm or shorter is referred to as the “cyan sub-pixel”, and a sub-pixel corresponding to a dominant wavelength of 470 nm or shorter is referred to as the “blue sub-pixel”.

Now, the display device 100 in this preferred embodiment will be described more specifically.

Table 1 shows the chromaticity x, y and the Y value in the XYZ color system of the color displayed by each sub-pixel.

TABLE 1

| | x | y | Y |
|---|---|---|---|
| R | 0.692866 | 0.295283 | 1.831831 |
| G | 0.159574 | 0.753667 | 2.230912 |
| B | 0.149084 | 0.043377 | 0.324874 |
| C | 0.13392 | 0.227145 | 1.504363 |
| Ye | 0.455744 | 0.518999 | 3.833641 |
| W | 0.330712 | 0.317179 | 9.72562 |

Table 2 shows a change in the luminance of each sub-pixel which is substantially the same as that shown in FIG. 4(c). Table 2 shows a specific example of the luminance change when the values of each sub-pixel shown in Table 1 are used.

TABLE 2

| R | G | B | C | Y | |
|---|---|---|---|---|---|
| 1.00 | 1.00 | 1.00 | 1.00 | 1.00 | White |
| \| | ↑ | \| | ↑ | \| | |
| \| | 0.50 | 1.00 | 0.00 | \| | |
| \| | ↑ | ↑ | \| | \| | |
| \| | 0.00 | 0.70 | \| | 1.00 | |
| \| | \| | ↑ | \| | ↑ | |
| 1.00 | \| | 0.00 | \| | 0.00 | Optimal color |
| ↑ | \| | \| | \| | \| | |
| 0.00 | 0.00 | 0.00 | 0.00 | 0.00 | Black |

As shown in Table 2, for changing the color displayed by the pixel from black via red to white, the luminance of the red sub-pixel first is increased from “0” to “1”. When the luminance of the red sub-pixel reaches “1”, the color displayed by the pixel is the optimal color in the hue (R). At this point, the luminances of the red, green, blue, cyan and yellow sub-pixels are respectively “1.00”, “0.00”, “0.00”, “0.00”, “0.00”.

When the luminance of the red sub-pixel reaches “1”, the luminances of the yellow and blue sub-pixels corresponding to two hues adjacent to the hue (R) in the chromaticity diagram of the L*a*b* color system (the hue (Ye) and the hue (B)) start to be increased. The increasing rate of the luminance of the yellow sub-pixel is larger than that of the blue sub-pixel.

When the luminance of the yellow sub-pixel reaches “1”, the luminance of the green sub-pixel starts to be increased. At this point, the luminances of the red, green, blue, cyan and yellow sub-pixels are respectively “1.00”, “0.00”, “0.70”, “0.00”, “1.00”. The hue (G) corresponding to the green sub-pixel is on the same side as the hue (Ye) with respect to the hue (R) in the chromaticity diagram of the L*a*b* color system, and is closest to the hue (R) next to the hue (Ye).

When the luminance of the blue sub-pixel reaches “1”, the luminance of the cyan sub-pixel starts to be increased. At this point, the luminances of the red, green, blue, cyan and yellow sub-pixels are respectively “1.00”, “0.50”, “1.00”, “0.00”, “1.00”. The hue (C) corresponding to the cyan sub-pixel is on the same side as the hue (B) with respect to the hue (R) in the chromaticity diagram of the L*a*b* color system, and is closest to the hue (R) next to the hue (B).

When the luminances of the green and cyan sub-pixels reach “1”, the color displayed by the pixel is white. At this point, the luminances of the red, green, blue, cyan and yellow sub-pixels are respectively “1.00”, “1.00”, “1.00”, “1.00”, “1.00”.

FIG. 7 is a color tone diagram showing the relationship between the chroma and the lightness when the luminance of each sub-pixel is changed as shown in Table 2. In FIG. 7, curve T2 represents the relationship between the chroma and the lightness when the luminance of each sub-pixel is changed as shown in Table 2, and Po represents the area of the hue (R) of the Pointer gamut. Where the luminance of each sub-pixel is changed as shown in Table 2, the color representation range of the display device 100 covers the area of the hue (R) of the Pointer gamut.

In the above description, after the luminance of the red sub-pixel reaches “1”, the luminances of the yellow and blue sub-pixels start to be increased. This preferred embodiment is not limited to this. The luminances of the yellow and blue sub-pixels may start to be increased after the luminance of the red sub-pixel reaches a level lower than “1”.

Hereinafter, a case where the luminances of the yellow and blue sub-pixels start to be increased after the luminance of the red sub-pixel reaches “0.8” will be described. Table 3 shows a change in the luminance of each sub-pixel in the display device 100 of this preferred embodiment. Table 3 also shows a specific example of the luminance change when the values of each sub-pixel shown in Table 1 are used.

TABLE 3

| R | G | B | C | Y | |
|---|---|---|---|---|---|
| 1.00 | 1.00 | 1.00 | 1.00 | 1.00 | White |
| ↑ | ↑ | \| | ↑ | \| | |
| 0.92 | 0.50 | 1.00 | 0.00 | \| | |
| ↑ | ↑ | ↑ | \| | \| | |
| 0.84 | 0.00 | 0.70 | \| | 1.00 | |
| ↑ | \| | ↑ | \| | ↑ | |
| 0.80 | \| | 0.00 | \| | 0.00 | Optimal color |
| ↑ | \| | \| | \| | \| | |
| 0.00 | 0.00 | 0.00 | 0.00 | 0.00 | Black |

As shown in Table 3, the luminance of the red sub-pixel first is increased from “0” to “0.8”. In this case, when the luminance of the red sub-pixel reaches “0.8”, the color displayed by the pixel is the optimal color in the hue (R). Then, the luminances of the yellow and blue sub-pixels corresponding to two hues adjacent to the hue (R) in the chromaticity diagram of the L*a*b* color system (the hue (Ye) and the hue (B)) start to be increased. The luminance of the red sub-pixel is also increased at a predetermined rate from “0.8”. The change in the luminances of the green, blue, cyan and yellow sub-pixels after this are substantially the same as those shown in Table 2. However, the luminance of the red sub-pixel increases at the predetermined rate from “0.8”, and reaches “1” at the same time as the luminances of the green and cyan sub-pixels.

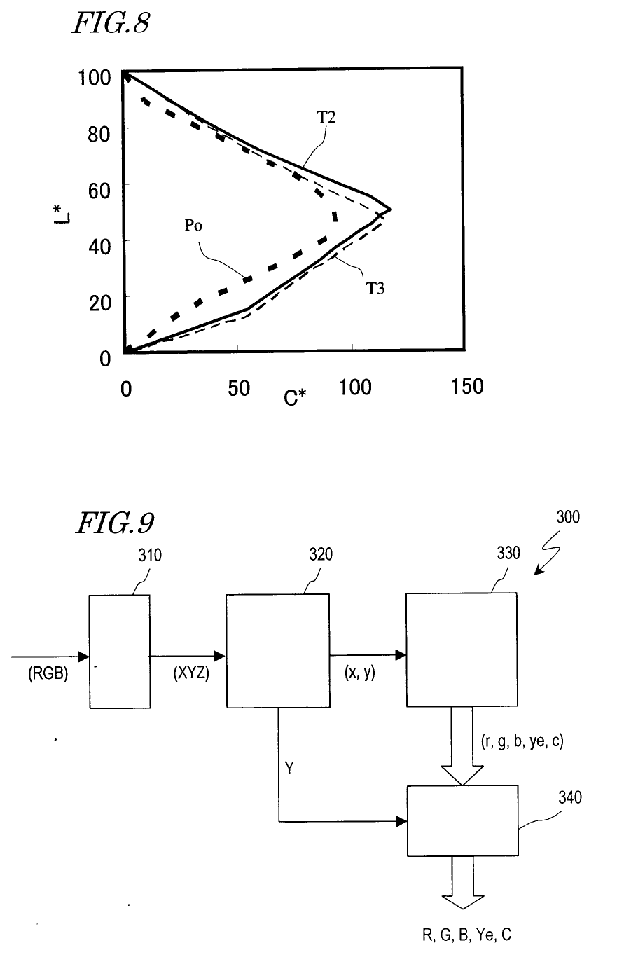

FIG. 8 is a color tone diagram when the luminance of each sub-pixel is changed as shown in Table 3. In FIG. 8, curve T3 represents the relationship between the chroma and the lightness when the luminance of each sub-pixel is changed as shown in Table 3, and Po represents the area of the hue (R) of the Pointer gamut. In FIG. 8, curve T2 represents the relationship between the chroma and the lightness when the luminance of each sub-pixel is changed as shown in Table 2.

Where the change in the luminance of each sub-pixel is controlled as shown in Table 3, the color representation range of the display device 100 covers the area of the hue (R) of the Pointer gamut. As described above, even when the luminances of the yellow and blue sub-pixels start to be increased before the luminance of the red sub-pixel reaches “1”, the object colors of the objects existing in the natural world can be represented more accurately.

In Table 2, after the luminance of the red sub-pixel reaches “1”, the luminances of the yellow and blue sub-pixels start to be increased. By contrast, in Table 3, after the luminance of the red sub-pixel reaches “0.8”, the luminances of the yellow and blue sub-pixels start to be increased. Therefore, as shown in FIG. 8, the lightness of the optimal color represented by curve T3 is lower than the lightness of the optimal color represented by curve T2. In general, as the luminance of the red sub-pixel is lower when the luminances of the yellow and blue sub-pixels start to be increased, the lightness of the optimal color is lower. Where the lightness of the optimal color is excessively low, the area of the hue (R) of the Pointer gamut is not sufficiently covered. Hence, the predetermined luminance of the red sub-pixel at which the luminances of the yellow and blue sub-pixels start to be increased is adjustable in the range with which the color representation range of the display device covers the area of the hue (R) of the Pointer gamut. Specifically, the luminance of the red sub-pixel at which the luminances of the yellow and blue sub-pixels start to be increased is adjustable in the range of “0.8” to “1”.

In Table 2, the luminance of one or two sub-pixels is increased at the same time. Alternatively, as shown in Table 3, the luminances of three sub-pixels may start to be increased at the same time to increase the lightness of the pixel. In this case, one of the three sub-pixels is the sub-pixel, among the plurality of sub-pixels, which starts to be increased in the luminance at the earliest time.

In the display device 100 of this preferred embodiment, the image processing circuit 300 may generate a signal to be input to the multi-color display panel 200 based on a TV signal. A TV signal is an RGB video signal. Therefore, in order to adapt the TV signal to the multi-color display panel 200, the image processing circuit 300 converts the RGB video signal into a multi-color display signal.

FIG. 9 is a schematic block diagram of the image processing circuit 300 in the display device 100 of this preferred embodiment.

The image processing circuit 300 includes a matrix calculation section 310 for generating an XYZ signal from an RGB signal, a separation section 320 for separately generating an (x, y) signal, and a Y value signal representing the Y value corresponding to the lightness, from the XYZ signal, a conversion circuit 330 for generating an (r, g, b, ye, c) signal from the (x, y) signal, and a synthesis section 340 for generating an (R, G, B, Ye, C) signal based on the (r, g, b, ye, c) signal and the Y value signal.

The RGB signal shows a luminance of each of red, green and blue sub-pixels when an image is displayed with these three primary colors. The matrix calculation section 310 generates the XYZ signal based on the RGB signal. The matrix calculation section 310 generates the XYZ signal representing XYZ, which is obtained by performing a calculation of a predetermined conversion expression using the luminances of the red, green and blue sub-pixels of the RGB signal.

The separation section 320 finds x and y from XYZ represented by the XYZ signal using a predetermined conversion expression, and outputs the (x, y) signal representing x and y to the conversion circuit 330. The separation section 320 also generates the Y value signal representing Y of XYZ, and outputs the Y value signal to the synthesis section 340. The Y value corresponds to the lightness. x and y in the (x, y) signal are values on the horizontal and vertical axes of the chromaticity diagram of the XYZ color system in FIG. 6. x and y specify the hue and the chroma of the color.

The conversion circuit 330 generates the (r, g, b, ye, c) signal based on the (x, y) signal by referring to a look-up table. The (r, g, b, ye, c) represented by the (r, g, b, ye, c) signal represents ratios of the luminances of the red, green, blue, yellow and cyan sub-pixels. The conversion circuit 330 has a look-up table prepared for each of r, g, b, ye and c. The value of each of r, g, b, ye and c is determined based on the x and y values. The hue and the chroma of the color are specified by (r, g, b, ye, c), but the chroma specified by (r, g, b, ye, c) may be occasionally higher than the chroma specified by x and y. The display device 100 in this preferred embodiment is also capable of representing a color having a chroma which cannot be represented by the conventional display device. The look-up tables may each be structured using, for example, a RAM such as a synchronous dynamic RAM (SDRAM) and a read only memory (ROM).

The conversion circuit 330 outputs the (r, g, b, ye, c) signal representing (r, g, b, ye, c) to the synthesis section 340. The synthesis section 340 generates the (R, G, B, Ye, C) signal based on the (r, g, b, ye, c) signal and the Y value signal. R, G, B, Ye and C in the (R, G, B, Ye, C) signal each represent the luminance (gray scale level) of the respective sub-pixel. The synthesis section 340 outputs the (R, G, B, Ye, C) signal to the multi-color display panel 200. The multi-color display panel 200 controls the luminance (gray scale level) of each sub-pixel such that the luminance (gray scale level) of each sub-pixel becomes the R, G, B, Ye and C represented by the (R, G, B, Ye, C) signal.

As described above, the display device 100 in this preferred embodiment can display an image with a wider color representation range even when the input signal is an RGB three primary color signal. The processing method used by the image processing circuit 300 is merely one example, and the (R, G, B, Ye, C) signal may be generated by any other method.

Now, a difference of the display device 100 in this preferred embodiment from the conventional display device will be described from a different point of view.

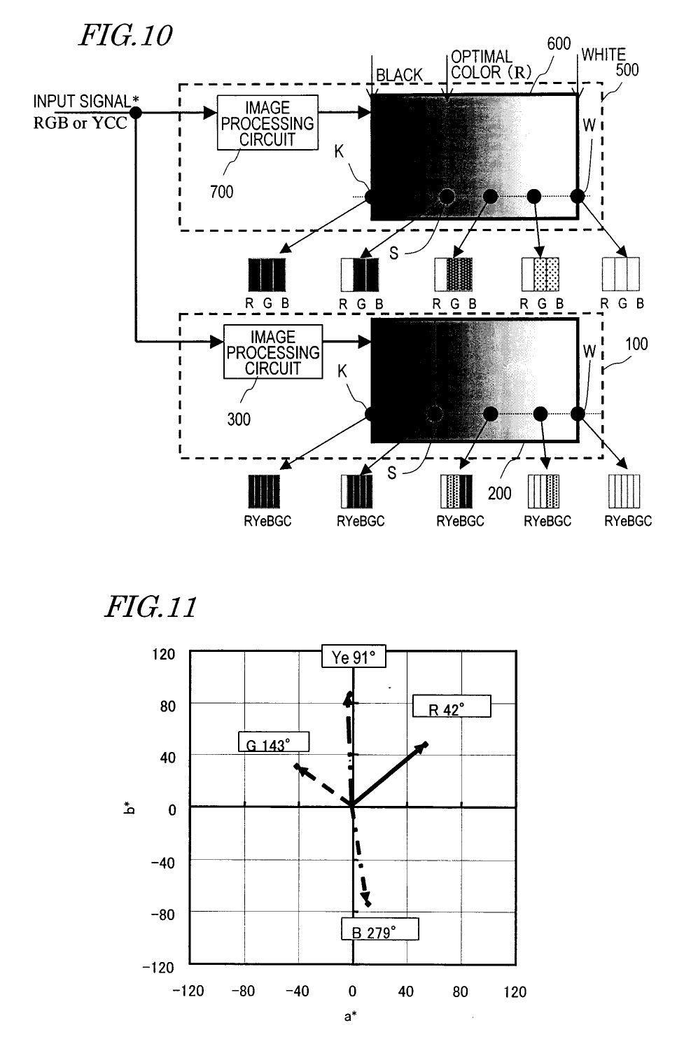

FIG. 10 is a schematic diagram for illustrating a difference of the display device 100 in this preferred embodiment from a conventional display device 500. In this example, an RGB three primary color signal is used as an input signal. The input signal may be a signal which can be converted into an RGB three primary color signal, such as a YCrCb signal generally used for color TVs. The conventional display device 500 includes a display panel 600 and an image processing circuit 700.

As shown in FIG. 10, the same input signal is input to the display device 100 in this preferred embodiment and the conventional display device 500. The input signal is a signal for allowing the entirety of the multi-color display panel 200 and the entirety of the display panel 600 to provide a gradation display from black via red to white. By using such an input signal, it can be easily confirmed whether or not the multi-primary color display device is the display device 100 in this preferred embodiment.

As shown in FIG. 10, in the multi-color display panel 200, the red, yellow, blue, green and cyan sub-pixels are strip-shaped, and are arranged in stripes in the order of the red, yellow, blue, green and cyan sub-pixels. In the display panel 600, the red, green and blue sub-pixels are strip-shaped, and are arranged in stripes in the order of the red, green and blue sub-pixels.

In the conventional display device 500, part K of the display panel 600 displays black. In part K, the luminances of all the sub-pixels are “0”. Part S of the display panel 600 displays the optimal color in the hue (R). In part S, the luminance of the red sub-pixel is “1” whereas the luminances of the green and blue sub-pixels are “0”. Part W of the display panel 600 displays white. In part W, the luminances of all the sub-pixels are “1”. Between part S and part W of the display panel 600, the luminances of the green and blue sub-pixels increase and the lightness of the pixel increases toward part W from part S.

In the display device 100 of this preferred embodiment, part K of the multi-color display panel 200 displays black. Therefore, in part K, the luminances of all the sub-pixels are “0”. Part S of the multi-color display panel 200 displays the optimal color. In part S, the luminance of the red sub-pixel is “1” whereas the luminances of the yellow, blue, green and cyan sub-pixels are “0”. Part W of the multi-color display panel 200 displays white. In part W, the luminances of all the sub-pixels are “1”. Here, as described above, the luminance “1” of the sub-pixel represents the luminance of each sub-pixel for realizing white when the color temperature is set to a desired level. Between part S and part W of the multi-color display panel 200, toward part W from part S, the luminances of the yellow and blue sub-pixels first increase. When the luminances of the yellow and blue sub-pixels become “1”, the luminances of the green and cyan sub-pixels increase. Thus, the lightness of the pixel is increased.

The luminance of each sub-pixel can be checked by observing the pixels in the multi-color display panel 200 and the display panel 600 during the gradation display in a state of being enlarged by a loupe or the like.

In the above description, the color displayed by the pixel changes via red. This preferred embodiment is not limited to this. The color displayed by the pixel may change via a color other than red, for example, green or blue.

For changing the color displayed by the pixel from black via green to white, the luminance of the green sub-pixel first starts to be increased. When the luminance of the green sub-pixel reaches a predetermined level, the luminances of the yellow and cyan sub-pixels start to be increased. When the luminance of the yellow sub-pixel reaches a predetermined level, the luminance of the red sub-pixel starts to be increased. When the luminance of the cyan sub-pixel reaches a predetermined level, the luminance of the blue sub-pixel starts to be increased.

For changing the color displayed by the pixel from black via blue to white, the luminance of the blue sub-pixel first starts to be increased. When the luminance of the blue sub-pixel reaches a predetermined level, the luminances of the red and cyan sub-pixels start to be increased. When the luminance of the red sub-pixel reaches a predetermined level, the luminance of the yellow sub-pixel starts to be increased. When the luminance of the cyan sub-pixel reaches a predetermined level, the luminance of the green sub-pixel starts to be increased. For changing the color displayed by the pixel via green or blue also, the predetermined luminance may be “0.8” or higher.

In the above description, the colors of the five sub-pixels are RGBYeC. This preferred embodiment is not limited to this. As the colors of sub-pixels, any colors are usable. It is preferable that the colors of the five sub-pixels include the RGB colors. The reason for this is that in general, the RGB colors are located in a relatively outer area within the spectrum locus of the chromaticity diagram of the XYZ color system shown in FIG. 6, and thus are likely to broaden the color representation range. It is preferable that the two colors added to the RGB colors are Ye and C for the following reason. The color reproducibility can be effectively increased by adding any of YeCM, which are complementary colors to the RGB colors. Especially, by adding Ye and C among YeCM, a higher color reproducibility and a higher luminance can be realized than by adding M. The reason for this is that Ye and C realize a pixel design providing a higher luminance and a higher chroma than M.

### Second Preferred Embodiment

In the display device in the first preferred embodiment, each pixel includes five sub-pixels. The number of the sub-pixels is not limited to five.

In a display device of this preferred embodiment, each pixel includes four sub-pixels. The four sub-pixels are red, yellow, green and blue sub-pixels. The display device in this preferred embodiment has substantially the same structure as that of the display device in the first preferred embodiment described above with reference to FIGS. 1 through 9 except for the number of the sub-pixels included in each pixel, and the repeated description thereof is omitted for avoiding redundancy.

FIG. 11 is a chromaticity diagram of the L*a*b* color system, in which a* and b* of each color of the four sub-pixels in the display device 100 of this preferred embodiment are plotted. FIG. 11 shows the hue angle of the color represented only by each sub-pixel. As shown in FIG. 11, the hue angle is 42° for R, 91° for Ye, 143° for G, and 279° for B. The colors shown in FIG. 11 are represented as the same as those shown in FIG. 3, but the hue angles shown in FIG. 11 are slightly different from those shown in FIG. 3. The reason for this is that the pixel design for realizing a highly efficient color reproducibility varies depending on the number of the sub-pixels or the colors thereof. Regarding the closeness of the hues to (R), the hue closest to (R) is (Ye) (hue angle difference: 49°), the hue next closest to (R) is (G) (hue angle difference: 101°), and the hue most remote from (R) is (B) (hue angle difference: 123°).

Hereinafter, a change of the color displayed by the pixel from black via red to white will be described.

With the display device 100 in this preferred embodiment, when the luminance of the red sub-pixel reaches a predetermined level, the luminances of the yellow and blue sub-pixels start to be increased. (Ye) corresponding to the yellow sub-pixel is closest to (R) and (B) corresponding to the blue sub-pixel is most remote from (R), but (B) is closest to (R) on the opposite side to (Ye) on the chromaticity diagram of the L*a*b* color system. In this manner, when the luminance of the red sub-pixel reaches a predetermined level, the luminances of the yellow and blue sub-pixels corresponding to two hues adjacent to (R) in the chromaticity diagram of the L*a*b* color system (i.e., (Ye) and (B)) start to be increased.

By increasing the luminances of the yellow and blue sub-pixels at predetermined rates, the lightness of the pixel can be increased without changing the hue (R). The increasing rate of the luminance of the yellow sub-pixel is larger than that of the blue sub-pixel. Therefore, the yellow sub-pixel reaches “1” before the blue sub-pixel. When the luminance of the yellow sub-pixel reaches “1”, the luminance of the green sub-pixel corresponding to (G) starts to be increased. When the luminances of all the sub-pixels become “1”, the color displayed by the pixel is white.

In the above description, the color displayed by the pixel changes via red. This preferred embodiment is not limited to this. The color displayed by the pixel may change via a color other than red, for example, green or blue.

In the above description, the colors of the four sub-pixels are RGBYe. This preferred embodiment is not limited to this. As the colors of sub-pixels, any colors are usable. It is preferable that the colors of the four sub-pixels include the RGB colors. The reason for this is that in general, the RGB colors are located in a relatively outer area within the spectrum locus of the chromaticity diagram of the XYZ color system shown in FIG. 6, and thus are likely to broaden the color representation range. It is preferable that the color added to the RGB colors is Ye for the following reason. The color reproducibility can be effectively increased by adding any of YeCM, which are complementary colors to the RGB colors. Especially, among YeCM, Ye realizes a pixel design providing the highest luminance and the highest chroma.

### Third Preferred Embodiment

In the display device in the first preferred embodiment, each pixel includes five sub-pixels. In the display device in the second preferred embodiment, each pixel includes four sub-pixels. The display device according to the present invention is not limited to these.

In a display device of this preferred embodiment, each pixel includes six sub-pixels. The six sub-pixels are red, yellow, green, blue, cyan and magenta sub-pixels. The display device in this preferred embodiment has substantially the same structure as that of the display device in the first preferred embodiment described above with reference to FIGS. 1 through 9 except for the number of the sub-pixels included in each pixel, and the repeated description thereof is omitted for avoiding redundancy.

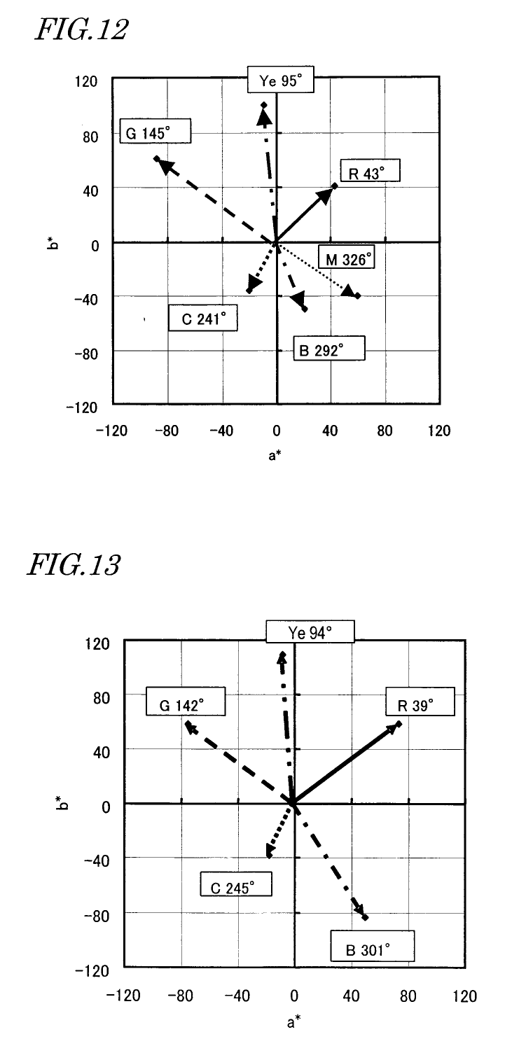

FIG. 12 is a chromaticity diagram of the L*a*b* color system, in which a* and b* of each color of the six sub-pixels in the display device 100 of this preferred embodiment are plotted. FIG. 12 shows the hue angle of the color represented only by each sub-pixel. As shown in FIG. 12, the hue angle is 43° for R, 95° for Ye, 145° for G, 241° for C, 292° for B, and 326° for M. The colors shown in FIG. 12 are represented as the same as those shown in FIGS. 3 and 11, but the hue angles shown in FIG. 12 are slightly different from those shown in FIGS. 3 and 11. The reason for this is that the pixel design for realizing a highly efficient color reproducibility varies depending on the number of the sub-pixels or the colors thereof. Regarding the closeness of the hues to (R), the hue closest to (R) is (Ye) (hue angle difference: 52°), the hue next closest to (R) is (M) (hue angle difference: 77°), the hue next closest to (R) is (G) (hue angle difference: 102°), the hue next closest to (R) is (B) (hue angle difference: 111°), and the hue most remote from (R) is (C) (hue angle difference: 162°).

Hereinafter, a change of the color displayed by the pixel from black via red to white will be described.

With the display device 100 in this preferred embodiment, when the luminance of the red sub-pixel reaches a predetermined level, the luminances of the yellow and magenta sub-pixels corresponding to two hues adjacent to (R) (i.e., (Ye) and (M)) start to be increased. When the luminance of the magenta sub-pixel reaches a predetermined level, the blue sub-pixel corresponding to (B), which is on the same side as (M) with respect to (R) and closest to (R) next to (M) in the chromaticity diagram of the L*a*b* color system, starts to be increased.

Then, when the luminance of the yellow sub-pixel reaches a predetermined level, the green sub-pixel corresponding to (G), which is on the same side as (Ye) with respect to (R) and closest to (R) next to (Ye) in the chromaticity diagram of the L*a*b* color system, starts to be increased. Since the increasing rate of the luminance of the blue sub-pixel is larger than that of the green sub-pixel, the blue sub-pixel reaches a predetermined level before the green sub-pixel. When the luminance of the blue sub-pixel reaches the predetermined level, the luminance of the cyan sub-pixel starts to be increased. When the luminances of all the sub-pixels become “1”, the color displayed by the pixel is white.

In the above description, the color displayed by the pixel changes via red. This preferred embodiment is not limited to this. The color displayed by the pixel may change via a color other than red, for example, green or blue.

For changing the color displayed by the pixel from black via green to white, the luminance of the green sub-pixel first starts to be increased. When the luminance of the green sub-pixel reaches a predetermined level, the luminances of the yellow and cyan sub-pixels start to be increased. When the luminance of the yellow sub-pixel reaches a predetermined level, the luminance of the red sub-pixel starts to be increased. When the luminance of the cyan sub-pixel reaches a predetermined level, the luminance of the blue sub-pixel starts to be increased. When the luminances of the red and blue sub-pixels reach a predetermined level, the luminance of the magenta sub-pixel starts to be increased.

For changing the color displayed by the pixel from black via blue to white, the luminance of the blue sub-pixel first starts to be increased. When the luminance of the blue sub-pixel reaches a predetermined level, the luminances of the magenta and cyan sub-pixels start to be increased. When the luminance of the magenta sub-pixel reaches a predetermined level, the luminance of the red sub-pixel starts to be increased. When the luminance of the cyan sub-pixel reaches a predetermined level, the luminance of the green sub-pixel starts to be increased. When the luminance of the red sub-pixel reaches a predetermined level, the luminance of the yellow sub-pixel starts to be increased.

### Fourth Preferred Embodiment

Hereinafter, a display device according to the fourth preferred embodiment of the present invention will be described with reference to the drawings.

The display device 100 in this preferred embodiment has substantially the same structure as that of the display device in the first preferred embodiment described above with reference to FIGS. 1 through 9, and the repeated description thereof is omitted for avoiding redundancy.

In the display devices in the first, second and third preferred embodiments, the color displayed by the pixel changes via any of red, green and blue. The display device according to the present invention is not limited to this. Unlike the display devices in the first, second and third preferred embodiments, the display device in this preferred embodiment changes the color displayed by the pixel via any of yellow, cyan and magenta, which are respectively complementary to red, blue and green. In this example, the color displayed by the pixel is yellow.

FIG. 13 is a chromaticity diagram of the L*a*b* color system, in which a* and b* of each color of the five sub-pixels in the display device 100 of this preferred embodiment are plotted. FIG. 13 shows the hue angle of the color represented only by each sub-pixel. As shown in FIG. 13, the hue angle is 39° for R, 94° for Ye, 142° for G, 245° for C, and 301° for B. Regarding the closeness of the hues to the hue (Ye) of Ye, the hue closest to (Ye) is (G) (hue angle difference: 48°), the hue next closest to (Ye) is (R) (hue angle difference: 55°), the hue next closest to (Ye) is (C) (hue angle difference: 151°), and the hue most remote from (Ye) is (B) (hue angle difference: 153°). (G) is in the counterclockwise direction with respect to (Ye), and (R) is in the clockwise direction with respect to (Ye). Namely, in the chromaticity diagram of the L*a*b* color system, (R) is on the opposite side to (G) with respect to (Ye).

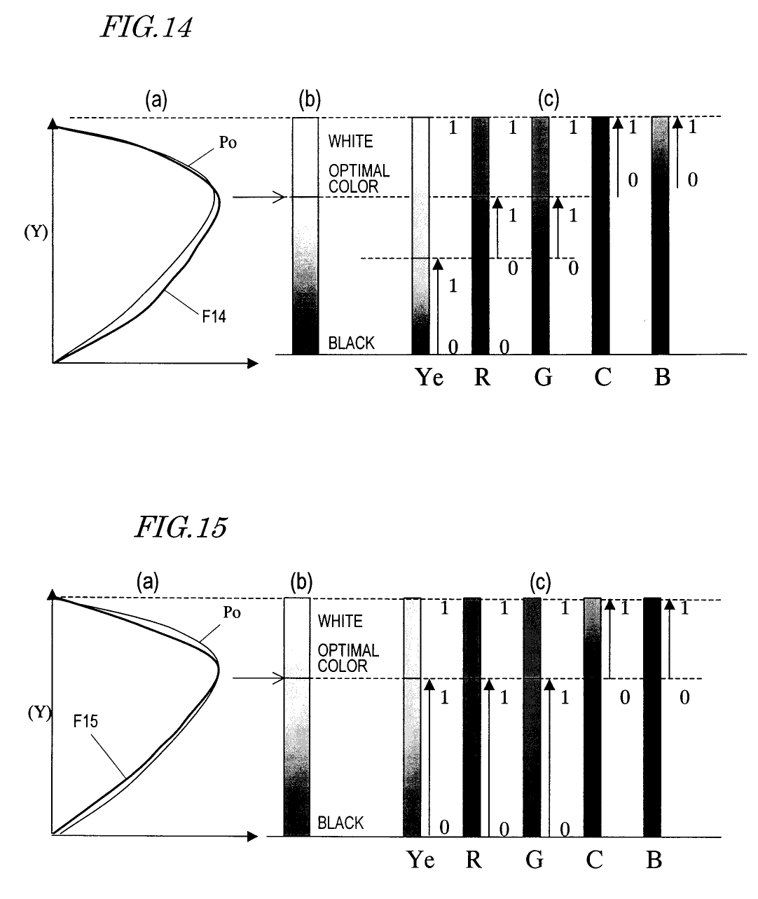

Hereinafter, with reference to FIG. 14, a change of the color displayed by the pixel from black via yellow to white will be described. FIG. 14 is a schematic diagram showing the relationship between a change in the luminance of each of the sub-pixels and the color representation range in the display device 100 of this preferred embodiment. FIG. 14(a) is a color tone diagram showing the color representation range of the pixel. FIG. 14(b) shows a change of the color displayed by the pixel, and FIG. 14(c) shows a change in the luminance of each of the yellow, red, green, cyan and blue sub-pixels.

As shown in FIG. 14(c), the luminances of all the sub-pixels are initially “0”, and the color displayed by the pixel is black. First, the luminance of the yellow sub-pixel starts to be increased. As the luminance of the yellow sub-pixel increases, the lightness and the chroma of the color displayed by the pixel increase. After reaching “1”, the luminance of the yellow sub-pixel is kept at “1”. Then, the luminances of the red and green sub-pixels start to be increased. The luminances of the red and green sub-pixels increase at the same rate, but the hue (Ye) does not change. As the luminances of the red and green sub-pixels increase, the lightness and the chroma of the color displayed by the pixel increase. When luminances of the red and green sub-pixels increase and as a result, the luminances of the yellow, red and green sub-pixels are “1”, the color displayed by the pixel is the optimal color in the hue (Ye).

After reaching “1”, the luminances of the red and green sub-pixels are kept at “1”. When the luminances of the red and green sub-pixels reach “1”, the luminances of the cyan and blue sub-pixels start to be increased. The luminances of the cyan and blue sub-pixels increase at the same rate, but the hue (Ye) does not change. When the luminances of the cyan and blue sub-pixels reach “1”, the luminances of all the sub-pixels are “1” and the color displayed by the pixel is white.

The color displayed by the pixel is changed as shown in FIG. 14(b) from black via the optimal color in the hue (Ye) to white by changing the luminance of each sub-pixel as described above.

Curve F14 in FIG. 14(a) represents the locus of the change in the chroma and the lightness of the color displayed by the pixel when the luminance of each sub-pixel is changed as shown in FIG. 14(c). In FIG. 14(a), Po shows an area of the hue (Ye) of the Pointer gamut. Since the color representation range of the display device 100 substantially covers the area of the hue (Ye) of the Pointer gamut, the display device 100 can represent (display) the maximum possible number of the object colors of the objects existing in the natural world.

With reference to FIGS. 13 and 14, the order of the sub-pixels in which the luminance is increased will be described. As described above with reference to FIG. 14, with the display device 100 in this preferred embodiment, the luminance of the yellow sub-pixel first starts to be increased and then the luminances of the red and green sub-pixels, and luminances of the cyan and blue sub-pixels start to be increased in this order, for the purpose of increasing the lightness of the pixel.

As described above with reference to FIG. 13, this order corresponds to the order of closeness of each two sub-pixels to the hue (Ye) in the clockwise and counterclockwise directions. The reason for this is considered as follows. Where merely the luminance of the yellow sub-pixel reaches “1”, the optimal color in the hue (Ye) is not obtained. In order to obtain the optimal color in the hue (Ye), it is necessary to increase the luminances of the red and green sub-pixels corresponding to (R) and (G) adjacent to (Ye), in addition to the yellow sub-pixel. Yellow represented by the yellow sub-pixel has a higher chroma than yellow represented by the red and green sub-pixels. Therefore, for increasing the chroma of the color displayed by the pixel, it is more advantageous to first start increasing the luminance of the yellow sub-pixel and, after the luminance of the yellow sub-pixel reaches “1”, to start increasing the luminances of the red and green sub-pixels. In this manner, the display device 100 in this preferred embodiment can increase the chroma of the hue (Ye) at each lightness and thus broaden the color representation range.

With the display device 100 in this preferred embodiment also, a combination of the luminances of the sub-pixels for displaying a color corresponding to each point on curve F14 in FIG. 14(a) is set based on the algorithm for setting the luminances of the sub-pixels as described above with reference to FIG. 14. In other words, FIG. 14(c) shows the timing to start lighting up the sub-pixels (the timing to start increasing the luminances), and also a combination itself of the luminances of the sub-pixels for displaying a color corresponding to each point on curve F14. The luminance of each sub-pixel may be prepared in advance based on the algorithm, or may be generated by calculations.

Now, the display device 100 in this preferred embodiment will be compared with a display device in a comparative example to explain the advantages of the display device 100 in this preferred embodiment. In the display device of the comparative example, each pixel includes five sub-pixels, i.e., yellow, red, green, cyan and blue sub-pixels like in the display device 100 of this preferred embodiment.

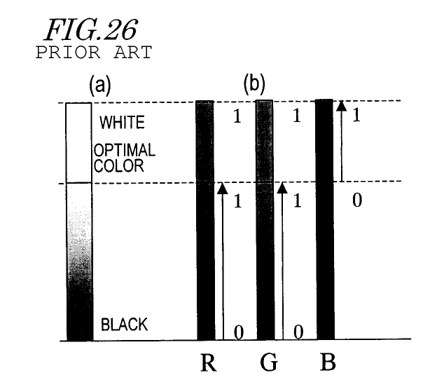

As described above with reference to FIG. 26, with the conventional display device, in order to display yellow, the luminances of the red and green sub-pixels start to be increased at the same time. The luminances of the red and green sub-pixels increase at the same rate. With the display device in the comparative example, the luminances of the yellow, red and green sub-pixels start to be increased at the same time, and the luminances of the yellow, red and green sub-pixels increase at the same rate. FIG. 15 is a schematic diagram showing the relationship between a change in the luminance of each of the sub-pixels and the color representation range in the display device of the comparative example. FIG. 15(a) is a color tone diagram showing the color representation range of the pixel. FIG. 15(b) shows a change of the color displayed by the pixel, and FIG. 15(c) shows a change in the luminance of each of the yellow, red, green, cyan and blue sub-pixels.

With the display device in the comparative example also, the luminances of all the sub-pixels, i.e., the yellow, red, green, cyan and blue sub-pixels are initially “0”, and the color displayed by the pixel is black. With the display device in the comparative example, the luminances of the yellow, red and green sub-pixels first start to be increased. The luminances of the yellow, red and green sub-pixels increase at the same rate. As the luminances of the yellow, red and green sub-pixels increase, the chroma and the lightness of the color displayed by the pixel increase.

When the luminances of the yellow, red and green sub-pixels reach “1”, the color displayed by the pixel is the optimal color in the hue (Ye). With the display device in the comparative example, when the luminances of the yellow, red and green sub-pixels reach “1”, the luminances of the cyan and blue sub-pixels start to be increased at the same time. When the luminances of all the sub-pixels become “1”, the color displayed by the pixel is white.

With the display device in the comparative example also, the color displayed by the pixel is changed as shown in FIG. 15(b) from black via yellow to white by changing the luminance of each sub-pixel as shown in FIG. 15(c). However, as shown in FIG. 15(a), the color representation range of the display device in the comparative example does not sufficiently cover the area of the hue (Ye) of the Pointer gamut. Therefore, the display device in the comparative example cannot sufficiently represent (display) the object colors of the objects existing in the natural world.

Comparing FIGS. 14(c) and 15(c), the display device 100 in this preferred embodiment and the display device in the comparative example both change the luminance of each sub-pixel in substantially the same manner from the time when the color displayed by the pixel is the optimal color until the time when the color displayed by the pixel is white, but not in the same manner from the time when the color displayed by the pixel is black until the time when the color displayed by the pixel is the optimal color in the hue (Ye). Specifically, with the display device 100 in this preferred embodiment, the luminance of the yellow sub-pixel first starts to be increased, and after the luminance of the yellow sub-pixel reaches “1”, the luminances of the red and green sub-pixels start to be increased. By contrast, with the display device in the comparative example, the luminances of the yellow, red and green sub-pixels start to be increased at the same time. As a result, curve F14 in FIG. 14(a) represents a relatively high chroma even at a lightness lower than the lightness of the optimal color; whereas curve F15 in FIG. 15(a) represents a relatively low chroma at a lightness lower than the lightness of the optimal color. The reason for this is the following. According to a usual pixel design, yellow displayed by the yellow sub-pixel is designed to have a higher chroma than yellow displayed by the red and green sub-pixels. Therefore, the chroma of the color displaying by the yellow sub-pixel only is higher than that of the color having the same luminance using the yellow, red and green sub-pixels.

Namely, the display device 100 in this preferred embodiment, which changes the luminances of the sub-pixels as described above, can represent a color having a high chroma which cannot be represented by the display device in the comparative example. Accordingly, the display device 100 in this preferred embodiment can increase the chroma at each lightness of the color displayed by the pixel, and thus display an image with a wide color representation range.

FIG. 16 is a schematic diagram for illustrating a difference of the display device 100 in this preferred embodiment from the conventional display device 500. An RGB three primary color signal is used as an input signal. The input signal may be a signal which can be converted into an RGB three primary color signal, such as a YCrCb signal generally used for color TVs. The conventional display device 500 includes a display panel 600 and an image processing circuit 700.

As shown in FIG. 16, the same input signal is input to the display device 100 in this preferred embodiment and the conventional display device 500. The input signal is a signal for allowing the entirety of the multi-color display panel 200 and the entirety of the display panel 600 to provide a gradation display from black via red to white. By using such an input signal, it can be easily confirmed whether or not the multi-primary color display device is the display device 100 in this preferred embodiment.

As shown in FIG. 16, in the multi-color display panel 200, the yellow, red, green cyan and blue sub-pixels are strip-shaped, and are arranged in stripes in the order of the yellow, red, green cyan and blue sub-pixels. In the display panel 600, the red, green and blue sub-pixels are strip-shaped, and are arranged in stripes in the order of the red, green and blue sub-pixels.

In the conventional display device 500, part K of the display panel 600 displays black. In part K, the luminances of all the sub-pixels are “0”. Part S of the display panel 600 displays the optimal color in the hue (Ye). In part S, the luminances of the red and green sub-pixels are “1” whereas the luminance of the blue sub-pixel is “0”. Part W of the display panel 600 displays white. In part W, the luminances of all the sub-pixels are “1”. Between part K and part S of the display panel 600, the luminances of the red and green sub-pixels increase and the lightness of the pixel increases toward part S from part K.

In the display device 100 of this preferred embodiment, part K of the multi-color display panel 200 displays black. Therefore, in part K, the luminances of all the sub-pixels are “0”. Part S of the multi-color display panel 200 displays the optimal color. In part S, the luminances of the yellow, red and green sub-pixels are “1” whereas the luminances of the cyan and blue sub-pixels are “0”. Part W of the multi-color display panel 200 displays white. In part W, the luminances of all the sub-pixels are “1”. Between part K and part S of the multi-color display panel 200, toward part S from part K, the luminance of the yellow sub-pixel is first increased. When the luminance of the yellow sub-pixel reaches “1”, the luminances of the red and green sub-pixels are increased. Thus, the lightness of the pixel is increased. Between part S and part W of the multi-color display panel 200, the luminances of the cyan and blue sub-pixels increase toward part W from part S. Thus, the lightness of the pixel is increased.

The luminance of each sub-pixel can be checked by observing the pixels in the multi-color display panel 200 and the display panel 600 during the gradation display in a state of being enlarged by a loupe or the like.

In the above description, after the luminance of the yellow sub-pixel reaches “1”, the luminances of the red and green sub-pixels are increased at the same rate. This preferred embodiment is not limited to this. The increasing rate of the luminance of the red sub-pixel and the increasing rate of the luminance of the green sub-pixel may be different.

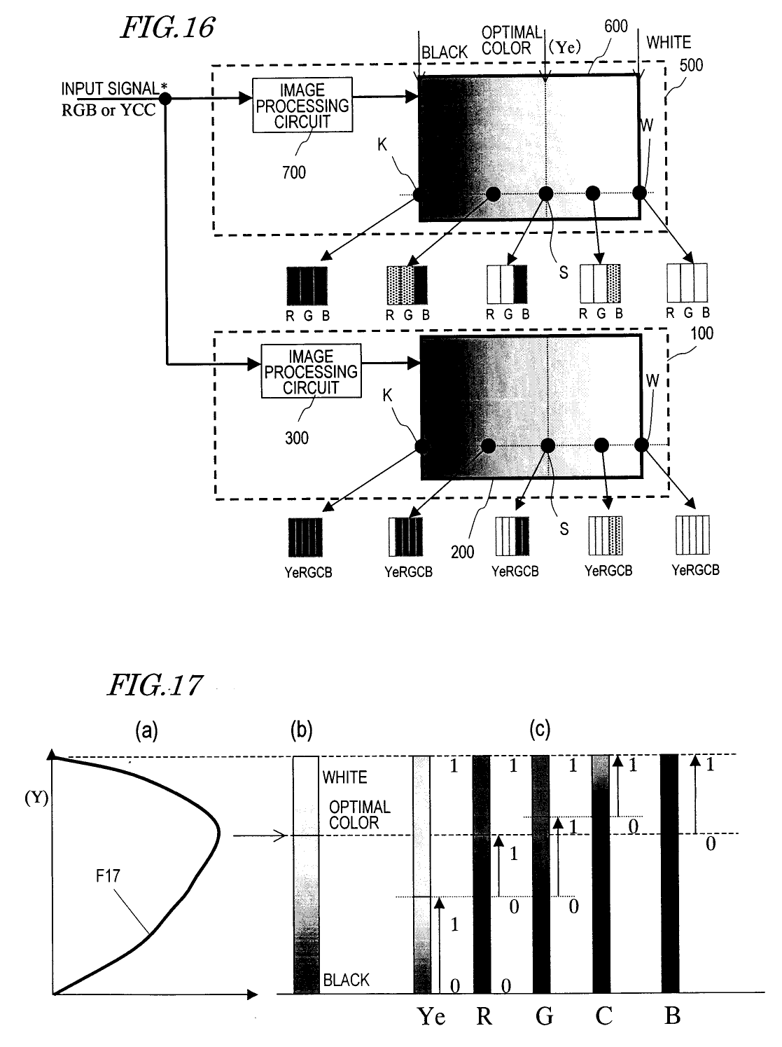

The increasing rate of the luminance of the green sub-pixel may be larger than the increasing rate of the luminance of the red sub-pixel. This will be described with reference to FIG. 17.

The luminances of all the sub-pixels, i.e., the yellow, red, green, cyan and blue sub-pixels are initially “0”, and the color displayed by the pixel is black. First, the luminance of the yellow sub-pixel starts to be increased. As the luminance of the yellow sub-pixel increases, the lightness of the pixel increases. After reaching “1”, the luminance of the yellow sub-pixel is kept at “1”. When the luminance of the yellow sub-pixel reaches “1”, the luminances of the red and green sub-pixels start to be increased in order to further increase the lightness of the pixel. The luminances of the red and green sub-pixels increase at different rates, but the hue (Ye) does not change.

The luminances of the red and green sub-pixels increase at the same rate in FIG. 14, but at different rates in FIG. 17. Specifically, the increasing rate of the luminance of the red sub-pixel is larger than the increasing rate of the luminance of the green sub-pixel. The reason for this is the following. The pixel is designed such that the yellow hue displayed by increasing the luminances of the red and green sub-pixels at the same rate is closer to green than the yellow hue displayed by the yellow sub-pixel. Therefore, it is necessary to increase the luminance of the red sub-pixel at a larger rate than the green sub-pixel in order to maintain the hue (Ye) without being changed. Accordingly, the luminance of the red sub-pixel reaches “1” before the luminance of the green sub-pixel.

When the luminance of the red sub-pixel reaches “1”, the color displayed by the pixel is the optimal color in the hue (Ye). In FIG. 14, the luminances of the yellow, red and green sub-pixels are “1” when the optimal color is represented. By contrast, in this example, when the optimal color is represented, the luminances of the yellow and red sub-pixels are “1” whereas the luminance of the green sub-pixel has not reached “1”. When the luminance of the red sub-pixel reaches “1”, the luminance of the blue sub-pixel starts to be increased. The increasing rate of the luminance of the blue sub-pixel is set such that the hue (Ye) does not change along with the increase in the luminances of the green and blue sub-pixels.

After reaching “1”, the luminance of the green sub-pixel is kept at “1”. When the luminance of the green sub-pixel reaches “1”, the luminance of the cyan sub-pixel starts to be increased. The luminance of the blue sub-pixel is also increased together with the luminance of the cyan sub-pixel. The increasing rate of the luminance of the cyan sub-pixel is set such that the hue (Ye) does not change along with the increase in the luminances of the blue and cyan sub-pixels. The luminances of cyan and blue sub-pixels reach “1” at the same time. When the luminances of all the sub-pixels reach “1”, the color displayed by the pixel is white.

Alternatively, the increasing rate of the luminance of the green sub-pixel may be larger than the increasing rate of the luminance of the red sub-pixel. This will be described with reference to FIG. 18.

The luminances of all the sub-pixels are initially “0”, and the color displayed by the pixel is black. First, the luminance of the yellow sub-pixel starts to be increased. As the luminance of the yellow sub-pixel increases, the lightness of the pixel increases. After reaching “1”, the luminance of the yellow sub-pixel is kept at “1”. When the luminance of the yellow sub-pixel reaches “1”, the luminances of the red and green sub-pixels start to be increased in order to further increase the lightness in the hue (Ye). The luminances of the red and green sub-pixels increase at different rates, but the hue (Ye) does not change.

The luminances of the red and green sub-pixels increase at the same rate in FIG. 14, but at different rates in FIG. 18. Specifically, the increasing rate of the luminance of the green sub-pixel is larger than the increasing rate of the luminance of the red sub-pixel. The reason for this is the following. The pixel is designed such that the yellow hue displayed by increasing the luminances of the red and green sub-pixels at the same rate is closer to red than the yellow hue displayed by the yellow sub-pixel. Therefore, it is necessary to increase the luminance of the green sub-pixel at a larger rate than that of the red sub-pixel in order to maintain the hue (Ye) without being changed. Accordingly, the luminance of the green sub-pixel reaches “1” before the luminance of the red sub-pixel.

When the luminance of the green sub-pixel reaches “1”, the color displayed by the pixel is the optimal color in the hue (Ye). In FIG. 14, the luminances of the yellow, red and green sub-pixels are “1” when the optimal color is represented. By contrast, in this example, when the optimal color is represented, the luminances of the yellow and green sub-pixels are “1” whereas the luminance of the red sub-pixel has not reached “1”. After reaching “1”, the luminance of the green sub-pixel is kept at “1”. When the luminance of the green sub-pixel reaches “1”, the luminance of the cyan sub-pixel starts to be increased. The luminance of the red sub-pixel is also increased together with the luminance of the cyan sub-pixel. The increasing rate of the luminance of the cyan sub-pixel is set such that the hue (Ye) does not change along with the increase in the luminances of the red and cyan sub-pixels.

After reaching “1”, the luminance of the red sub-pixel is kept at “1”. When the luminance of the red sub-pixel reaches “1”, the luminance of the blue sub-pixel starts to be increased. The luminance of the cyan sub-pixel is also increased together with the luminance of the blue sub-pixel. The increasing rate of the luminance of the blue sub-pixel is set such that the hue (Ye) does not change along with the increase in the luminances of the cyan and blue sub-pixels. The luminances of the cyan and blue sub-pixels reach “1” at the same time. When the luminances of all the sub-pixels reach “1”, the color displayed by the pixel is white. As understood from this, the increasing rate of the luminance of the red sub-pixel does not need to be the same as the increasing rate of the luminance of the blue sub-pixel.

In the above description, the color displayed by the pixel changes via yellow. This preferred embodiment is not limited to this. The color displayed by the pixel may change via magenta or cyan.

For changing the color displayed by the pixel from black via green to magenta, the luminances of the red and blue sub-pixels first start to be increased. When the luminance of the red sub-pixel reaches a predetermined level, the luminance of the yellow sub-pixel starts to be increased. When the luminance of the blue sub-pixel reaches a predetermined level, the luminance of the cyan sub-pixel starts to be increased. When the luminances of the yellow and cyan sub-pixels reach a predetermined level, the luminance of the green sub-pixel starts to be increased.

For changing the color displayed by the pixel from black via cyan to white, the luminance of the cyan sub-pixel first starts to be increased. When the luminance of the cyan sub-pixel reaches a predetermined level, the luminances of the green and blue sub-pixels start to be increased. When the luminance of the green sub-pixel reaches a predetermined level, the luminance of the yellow sub-pixel starts to be increased. When the luminance of the blue sub-pixel reaches a predetermined level, the luminance of the red sub-pixel starts to be increased.

### Fifth Preferred Embodiment

In the display device in the fourth preferred embodiment, each pixel includes five sub-pixels. The number of the sub-pixels is not limited to five. In a display device of this preferred embodiment, each pixel includes four sub-pixels. The four sub-pixels are yellow, red, green and blue sub-pixels.

Hereinafter, a display device according to the fifth preferred embodiment of the present invention will be described with reference to the drawings.

The display device in this preferred embodiment has substantially the same structure as that of the display device in the fourth preferred embodiment described above with reference to FIGS. 1 through 9 except for the number of the sub-pixels included in each pixel, and the repeated description thereof is omitted for avoiding redundancy.

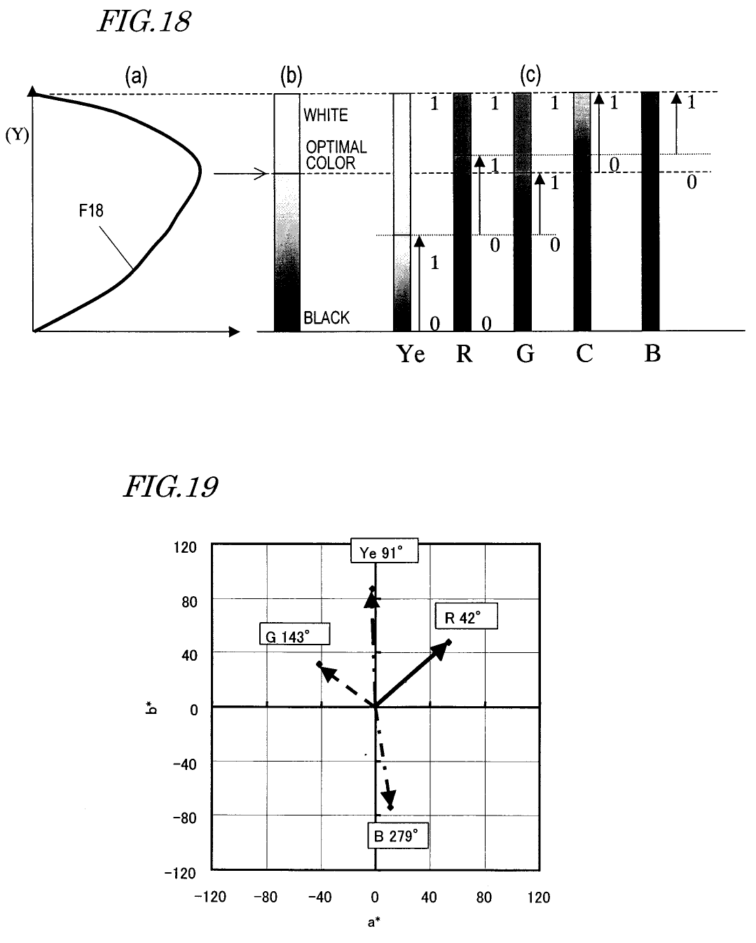

FIG. 19 is a chromaticity diagram of the L*a*b* color system, in which a* and b* of each color of the four sub-pixels in the display device 100 of this preferred embodiment are plotted. FIG. 19 shows the hue angle of the color represented only by each sub-pixel. As shown in FIG. 19, the hue angle is 42° for R, 91° for Ye, 143° for G, and 279° for B.

Regarding the closeness of the hues to (Ye), the hue closest to (Ye) is (R) (hue angle difference: 49°), the hue next closest to (Ye) is (G) (hue angle difference: 52°), and the hue most remote from (Ye) is (B) (hue angle difference: 172°).

Hereinafter, a change of the color displayed by the pixel from black via yellow to white will be described.

With the display device 100 in this preferred embodiment, when the luminance of the yellow sub-pixel reaches a predetermined level, the luminances of the red and green sub-pixels start to be increased. (R) corresponding to the red sub-pixel is closest to the hue (Ye) in the clockwise direction, and (G) corresponding to the green sub-pixel is closest to the hue (Ye) in the counterclockwise direction.

Now, a change of the color displayed by the pixel from black via yellow to white will be described.

The luminance of the yellow sub-pixel first starts to be increased. As the luminance of the yellow sub-pixel increases, the lightness of the pixel increases. After reaching “1”, the luminance of the yellow sub-pixel is kept at “1”. Then, the luminances of the red and green sub-pixels start to be increased in order to further increase the lightness of the pixel. The luminances of the red and green sub-pixels increase at the same rate, but the hue (Ye) does not change. When the luminances of the red and green sub-pixels increase and as a result, the luminances of the yellow, red and green sub-pixels are “1”, the color displayed by the pixel is the optimal color in the hue (Ye). When the luminances of the red and green sub-pixels reach “1”, the luminance of the blue sub-pixel starts to be increased. The hue (B) has a hue angle difference of approximately 180° from the hue (Ye). When the luminance of only the blue sub-pixel is increased, the hue (Ye) does not change almost at all.

In the above description, the color displayed by the pixel changes via yellow. This preferred embodiment is not limited to this. The color displayed by the pixel may change via magenta or cyan.

In the above description, the colors of the four sub-pixels are RGBYe. This preferred embodiment is not limited to this. As the colors of sub-pixels, any colors are usable. It is preferable that the colors of the four sub-pixels include the RGB colors. The reason for this is that in general, the RGB colors are located in a relatively outer area within the spectrum locus of the chromaticity diagram of the XYZ color system shown in FIG. 6, and thus are likely to broaden the color representation range. It is preferable that the color added to the RGB colors is Ye for the following reason. The color reproducibility can be effectively increased by adding any of YeCM, which are complementary colors to the RGB colors. Among YeCM, Ye realizes a pixel design providing a high luminance and a high chroma.

### Sixth Preferred Embodiment

In the display device in the fourth preferred embodiment, each pixel includes five sub-pixels. In the display device in the fifth preferred embodiment, each pixel includes four sub-pixels. The display device according to the present invention is not limited to these.

In a display device of this preferred embodiment, each pixel includes four six pixels. The six sub-pixels are yellow, red, green, cyan, blue and magenta sub-pixels. The display device in this preferred embodiment has substantially the same structure as that of the display device in the fourth and fifth preferred embodiments described above with reference to FIGS. 1 through 9 except for the number of the sub-pixels included in each pixel, and the repeated description thereof is omitted for avoiding redundancy.

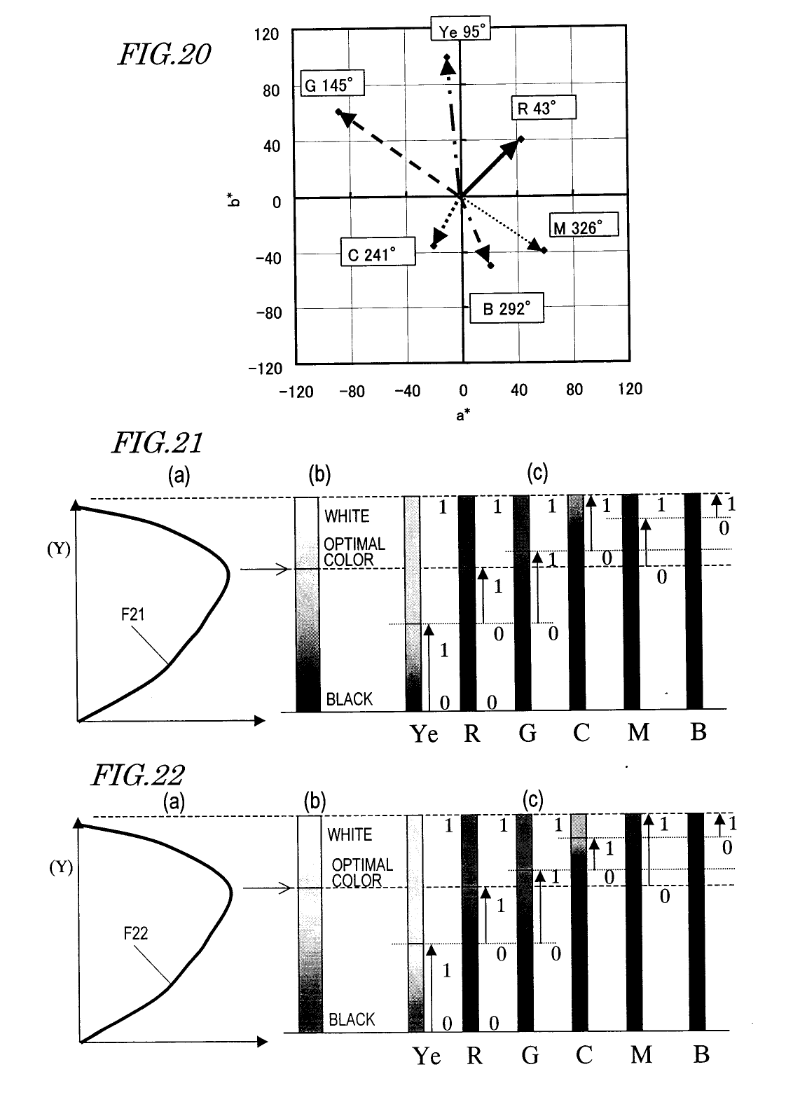

FIG. 20 is a chromaticity diagram of the L*a*b* color system, in which a* and b* of each color of the six sub-pixels in the display device 100 of this preferred embodiment are plotted. FIG. 20 shows the hue angle of the color represented only by each sub-pixel. As shown in FIG. 20, the hue angle is 43° for R, 95° for Ye, 145° for G, 241° for C, 292° for B, and 326° for M. Regarding the closeness of the hues to (Ye), the hue closest to (Ye) is (G) (hue angle difference: 50°), the hue next closest to (Ye) is (R) (hue angle difference: 52°), the hue next closest to (Ye) is (M) (hue angle difference: 1290), the hue next closest to (Ye) is (C) (hue angle difference: 1460), and the hue most remote from (Ye) is (B) (hue angle difference: 1630).

Hereinafter, a change of the color displayed by the pixel from black via yellow to white will be described with reference to FIGS. 20 and 21.

FIG. 21 is a schematic diagram showing the relationship between a change in the luminance of each of the sub-pixels and the color representation range in the display device 100 of this preferred embodiment. (a) is a color tone diagram showing the color representation range of the pixel. (b) shows a change of the color displayed by the pixel, and (c) shows a change in the luminance of each of the yellow, red, green, cyan, magenta and blue sub-pixels.

Initially, the luminances of all the sub-pixels are “0”, and the color displayed by the pixel is black. First, the luminance of the yellow sub-pixel starts to be increased. As the luminance of the yellow sub-pixel increases, the chroma and the lightness of the pixel increase. After reaching “1”, the luminance of the yellow sub-pixel is kept at “1”. When the luminance of the yellow sub-pixel reaches “1”, the luminances of the red and green sub-pixels start to be increased in order to further increase the lightness in the hue (Ye). In the chromaticity diagram of the L*a*b* color system, (R) and (G) corresponding to the red and green sub-pixels are adjacent to (Ye) on both sides.

The increasing rate of the luminance of the red sub-pixel is larger than that of the green sub-pixel. The increasing rates thereof are set such that the hue (Ye) does not change along with the increase in the luminances of the red and green sub-pixels. Since the increasing rate of the luminance of the red sub-pixel is larger than that of the green sub-pixel, the luminance of the red sub-pixel reaches “1” before the luminance of the green sub-pixel. When the luminances of the yellow and red reach “1”, the color displayed by the pixel is the optimal color in the hue (Ye).

When the luminance of the red sub-pixel reaches “1”, the luminance of the magenta sub-pixel starts to be increased. The hue (M) corresponding to the magenta sub-pixel is closest to the hue (Ye) next to the hue (R) in the clockwise direction. The increasing rate of the luminance of the magenta sub-pixel is set such that the hue (Ye) does not change along with the increase in the luminances of the green and magenta sub-pixels.

The luminance of the magenta sub-pixel is increased together with the luminance of the green sub-pixel. The luminance of the green sub-pixel reaches “1” before the magenta sub-pixel. When the luminance of the green sub-pixel reaches “1”, the luminance of the cyan sub-pixel starts to be increased. The hue (C) corresponding to the cyan sub-pixel is closest to the hue (Ye) next to the hue (G) in the counterclockwise direction. The increasing rate of the luminance of the cyan sub-pixel is set such that the hue (Ye) does not change along with the increase in the luminances of the magenta and cyan sub-pixels.

The luminance of the cyan sub-pixel is increased together with the luminance of the magenta sub-pixel. The luminance of the magenta sub-pixel reaches “1” before the luminance of the cyan sub-pixel. When the magenta sub-pixel reaches a predetermined level, the luminance of the blue sub-pixel starts to be increased. The luminance of the cyan sub-pixel and the luminance of the blue sub-pixel reach “1” at the same time. The increasing rate of the luminance of the blue sub-pixel is set such that the hue (Ye) does not change along with the increase in the luminances of the cyan and blue sub-pixels. When the luminances of all the sub-pixels become “1”, the color displayed by the pixel is white.

In the above description, as shown in FIG. 20, the hue (B) is in the clockwise direction, i.e., on the same side as the hues (R) and (B), with respect to the hue (Ye). This preferred embodiment is not limited to this. The hue (B) may be in the counterclockwise direction, i.e., on the same side as the hues (G) and (C), with respect to the hue (Ye). In this case, as shown in FIG. 22, after the luminance of the cyan sub-pixel reaches “1”, the luminance of the blue sub-pixel may start to be increased.

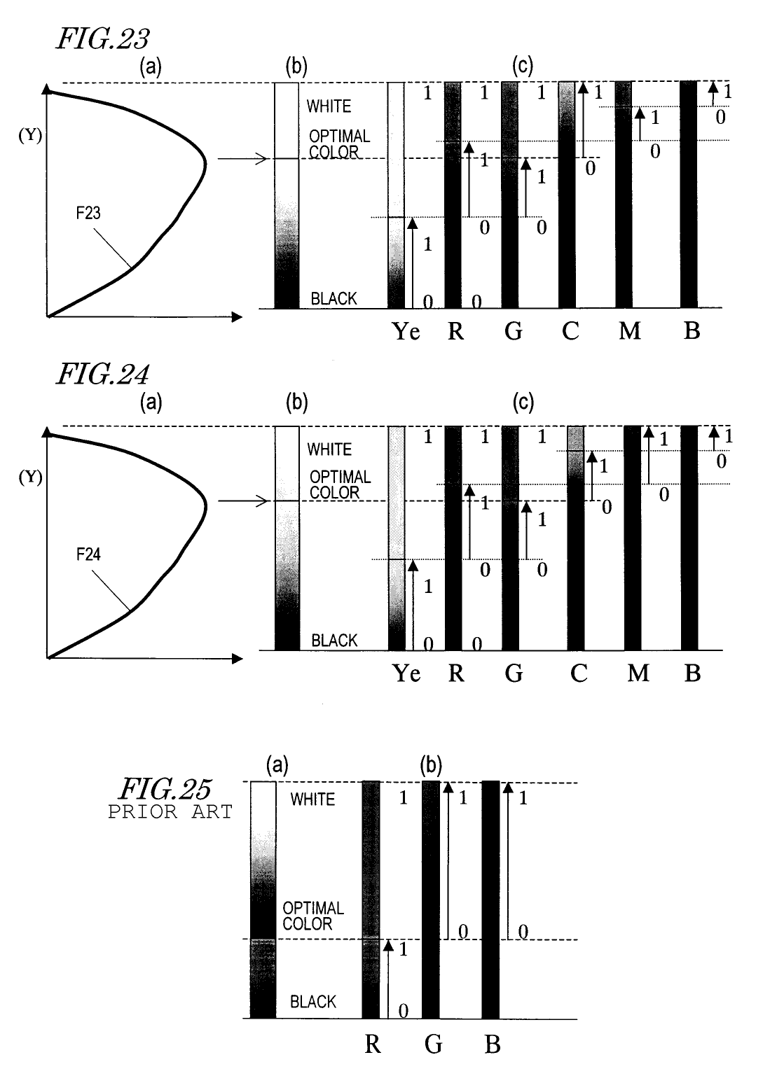

In the above description, the increasing rate of the luminance of the red sub-pixel is larger than that of the green sub-pixel. This preferred embodiment is not limited to this. As shown in FIG. 23, the increasing rate of the luminance of the green sub-pixel may be larger than that of the red sub-pixel. In this case, when the luminances of the yellow and green sub-pixels reach “1”, the color displayed by the pixel is the optimal color in the hue (Ye). Like in the case described above with reference to FIG. 21, when the luminance of the green sub-pixel reaches “1”, the luminance of the cyan sub-pixel starts to be increased; when the luminance of the red sub-pixel reaches “1”, the luminance of the magenta sub-pixel starts to be increased; and when the luminance of the magenta sub-pixel reaches “1”, the luminance of the blue sub-pixel starts to be increased.

With reference to FIG. 23 also, the hue (B) is in the clockwise direction, i.e., on the same side as the hues (R) and (M), with respect to the hue (Ye). This preferred embodiment is not limited to this. The hue (B) may be in the counterclockwise direction, i.e., on the same side as the hues (G) and (C), with respect to the hue (Ye). In this case, as shown in FIG. 24, after the luminance of the cyan sub-pixel reaches “1”, the luminance of the blue sub-pixel may start to be increased.

In the above description, the color displayed by the pixel changes via yellow. This preferred embodiment is not limited to this. The color displayed by the pixel may change via magenta or cyan.

For changing the color displayed by the pixel from black via green to magenta, the luminance of the magenta sub-pixel first starts to be increased. When the luminance of the magenta sub-pixel reaches a predetermined level, the luminances of the red and blue sub-pixels start to be increased. When the luminance of the red sub-pixel reaches a predetermined level, the luminance of the yellow sub-pixel starts to be increased. When the luminance of the blue sub-pixel reaches a predetermined level, the luminance of the cyan sub-pixel starts to be increased. When the luminances of the yellow and cyan sub-pixels reach a predetermined level, the luminance of the green sub-pixel starts to be increased.

For changing the color displayed by the pixel from black via cyan to white, the luminance of the cyan sub-pixel first starts to be increased. When the luminance of the cyan sub-pixel reaches a predetermined level, the luminances of the green and blue sub-pixels start to be increased. When the luminance of the green sub-pixel reaches a predetermined level, the luminance of the yellow sub-pixel starts to be increased. When the luminance of the blue sub-pixel reaches a predetermined level, the luminance of the magenta sub-pixel starts to be increased. When the luminance of the magenta sub-pixel reaches a predetermined level, the luminance of the red sub-pixel starts to be increased.

With the display devices 100 in the first, second and third preferred embodiments, a combination of luminances of sub-pixels corresponding to any of the RGB colors is set. With the display devices 100 in the fourth, fifth and sixth preferred embodiments, a combination of luminances of sub-pixels corresponding to any of the YeCM colors is set. One display device may set a combination of luminances of sub-pixels corresponding to any of the RGB colors for displaying any of the RGB colors like in the display devices in the first, second and third preferred embodiments, and set a combination of luminances of sub-pixels corresponding to any of the YeCM colors for displaying any of the YeCM colors like in the display devices in the fourth, fifth and sixth preferred embodiments.

With the above-described display devices 100 in the first through sixth preferred embodiments, each pixel includes a plurality of sub-pixels. The present invention is not limited to this.

The display device 100 in this preferred embodiment may be driven by a field sequential system. According to the field sequential system, color display is performed by forming one frame with a plurality of sub frames corresponding to primary colors respectively. The same effects as those described above can be provided by setting the luminances (display gray scale levels) of the sub frames corresponding to the respective primary colors so as to match the combination of the luminances of the sub-pixels shown in FIG. 4(c) or the like. In this case, the multi-color panel 200 includes four or more light sources for outputting light beams having different wavelengths, and the light sources are lit up sequentially in one field. The light sources may be fluorescent tubes or LEDs.

In the above-described display devices 100 in the first through sixth preferred embodiments, a liquid crystal panel is used as the multi-color panel 200. This preferred embodiment is not limited to this. The multi-color panel may be any display panel capable of displaying multiple colors, such as a CRT, a plasma display panel (PDP), an SED display panel, a liquid crystal projector or the like.

The elements included in the mage processing circuit 300 of the above-described display devices 100 in firth through sixth preferred embodiments may be implemented with hardware or may be partially or entirely implemented with software. Where the elements are implemented with software, a computer may be used. Such a computer includes a CPU (Central Processing Unit) for executing various programs, a RAM (Random Access Memory) acting as a work area for executing these programs, and the like. A program for realizing the function of each element is executed by the computer, and the computer acts as each element.

The program may be supplied to the computer from a recording medium or via a communication network. The recording medium may be separable from the computer or may be incorporated into the computer. The recording medium may be mounted on the computer such that the computer can directly read the recorded program code, or may be mounted on the computer such that the computer can read the recorded program code via a program reader connected to the computer as an external storage. Examples of usable recording mediums include tapes such as magnetic tapes, cassette tapes and the like; discs including, for example, magnetic discs such as flexible discs, hard discs and the like, magneto-optical discs such as MOs, MDs and the like, and optical discs such as CD-ROMs, DVDs, CD-Rs; cards such as IC cards (including memory cards), optical cards and the like; semiconductor memories such as mask ROMs, EPROMs (Erasable Programmable Read Only Memories), EEPROMs (Electrically Erasable Programmable Read Only Memories), flash ROMs and the like. When the program is supplied via a communication network, the program is in the form of a carrier wave or a data signal embodying the program code by electronic transmission.

A display device according to the present invention is preferably usable for, for example, a monitor of a personal computer, a liquid crystal TV, a liquid crystal projector, a display panel of a mobile phone, or the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-15. (canceled)

16. A display device comprising a pixel defined by a plurality of sub-pixels; wherein:
the plurality of sub-pixels include a first sub-pixel representing a first color having a first hue, a second sub-pixel representing a second color having a second hue, a third sub-pixel representing a third color having a third hue, and a fourth sub-pixel representing a fourth color having a fourth hue;
the second hue is closest to the first hue in a chromaticity diagram of the L*a*b* color system among the hues of the plurality of sub-pixels, and the third hue is closest to the first hue on the opposite side to the second hue with respect to the first hue in the chromaticity diagram of the L*a*b* color system among the hues of the plurality of sub-pixels; and
the luminances of the plurality of sub-pixels are set such that while a color displayed by the pixel changes from black via the first color to white, the luminance of the first sub-pixel starts to be increased, and when the luminance of the first sub-pixel reaches a predetermined luminance, the luminance of at least one of the second sub-pixel and the third sub-pixel among the plurality of sub-pixels starts to be increased.

17. The display device of claim 16, wherein the luminances of the second sub-pixel and the third sub-pixel start to be increased such that the hue of the color displayed by the pixel does not change from the first hue.

18. The display device of claim 16, wherein the luminance of the sub-pixel corresponding to a hue most remote from the first hue among the hues of the plurality of sub-pixels starts to be increased after the luminances of the other sub-pixels start to be increased.

19. The display device of claim 16, wherein:
the first color is any one of red, green and blue; and
when the luminance of the first sub-pixel reaches the predetermined luminance, the color displayed by the pixel is the optimal color in the first hue.

20. The display device of claim 16, wherein:
the first color is any one of yellow, cyan and magenta; and
when the luminances of the first, second and third sub-pixels reach respective predetermined luminances, the color displayed by the pixel is the optimal color in the first hue.

21. The display device of claim 16, wherein when the luminance of one of the second and third sub-pixels reaches a predetermined luminance, the luminance of the fourth sub-pixel starts to be increased.

22. The display device of claim 16, wherein the rate of the predetermined luminance with respect to the luminance corresponding to the highest gray scale level of the first sub-pixel is “0.8” or greater and “1” or less.

23. The display device of claim 22, wherein the predetermined luminance is the luminance corresponding to the highest gray scale level of the first sub-pixel.

24. The display device of claim 16, wherein in the case where the first, second, third and fourth colors are any of red, green, blue and yellow,
when the first color is red, the second and third colors are yellow and blue;
when the first color is green, the second and third colors are yellow and blue;
when the first color is blue, the second and third colors are red and green; and
when the first color is yellow, the second and third colors are red and green.

25. The display device of claim 16, wherein:
the plurality of sub-pixels further include a fifth sub-pixel representing a fifth color having a fifth hue;
the fifth hue is closest to the first hue next to the second hue on the same side as the second hue with respect to the first hue in the chromaticity diagram of the L*a*b* color system among the hues of the plurality of sub-pixels; and
when the luminance of the second sub-pixel reaches a predetermined luminance, the luminance of the fifth sub-pixel starts to be increased.

26. The display device of claim 25, wherein:
the first color is any one of yellow, cyan and magenta; and
when the luminances of the first, second and third sub-pixels reach respective predetermined luminances, the luminances of the fourth and fifth sub-pixels start to be increased at the same time.

27. The display device of claim 25, wherein in the case where the first, second, third, fourth and fifth colors are any of red, green, blue, yellow and cyan,
when the first color is red, the second and third colors are yellow and blue;
when the first color is green, the second and third colors are yellow and cyan;
when the first color is blue, the second and third colors are red and cyan;
when the first color is yellow, the second and third colors are red and green; and
when the first color is cyan, the second and third colors are blue and green.

28. The display device of claim 25, wherein:
the plurality of sub-pixels further include a sixth sub-pixel representing a sixth color having a sixth hue;
the sixth hue is closest to the first hue next to the third hue on the same side as the third hue with respect to the first hue in the chromaticity diagram of the L*a*b* color system among the hues of the plurality of sub-pixels; and
when the luminance of the third hue reaches a predetermined luminance, the luminance of the sixth sub-pixel starts to be increased.

29. The display device of claim 28, wherein in the case where the first, second, third, fourth, fifth and sixth colors are any of red, green, blue, yellow, cyan and magenta,
when the first color is red, the second and third colors are yellow and magenta;
when the first color is green, the second and third colors are yellow and cyan;
when the first color is blue, the second and third colors are magenta and cyan;
when the first color is yellow, the second and third colors are red and green;
when the first color is cyan, the second and third colors are blue and green; and
when the first color is magenta, the second and third colors are blue and red.

30. A display device comprising a pixel, wherein:
the pixel can perform display with any combination of a first color having a first hue, a second color having a second hue, a third color having a third hue and a fourth color having a fourth hue at any luminance;
the second hue is closest to the first hue in a chromaticity diagram of the L*a*b* color system among the hues of the pixel, and the third hue is closest to the first hue on the opposite side to the second hue with respect to the first hue in the chromaticity diagram of the L*a*b* color system among the hues of the pixel; and
the luminances of the colors of the pixel are set such that while a color displayed by the pixel changes from black via the first color to white, the luminance of the first color starts to be increased, and when the luminance of the first color reaches a predetermined luminance, the luminance of at least one of the second color and the third color starts to be increased.
